(19) United States
(12) Patent Application Publication
(10) Pub. No.: US 2026/0268479 A1
(43) Pub. Date: Sep. 10, 2026

(54) REGISTERING DIGITAL REPRESENTATIONS OF INTERCONNECTED LAYERS OF MULTILAYER DATASETS

(71) Applicant: TECHINSIGHTS INC., Ottawa (CA)

(72) Inventors: Christopher PAWLOWICZ, Ottawa (CA); Michael GREEN, Nepean (CA); Bruno MACHADO TRINDADE, Kanata (CA); Hamed BAGHERI, Ottawa (CA); Nabil David BASSIM, Hamilton (CA); Nasim KHOONKARI, Hamilton (CA); Christopher Kumar ANAND, Dundas (CA)

(21) Appl. No.: 19/480,334

(22) PCT Filed: Apr. 26, 2024
(86) PCT No.: PCT/CA2024/050571

§ 371 Date: Oct. 30, 2025

(30) Foreign Application Priority Data
May 1, 2023 (CA) 3198323

(51) Int. Cl. G06T 7/00; G06T 7/33

(52) U.S. Cl. CPC G06T 7/001; G06T 7/337; G06T 2207/30148

(57) ABSTRACT

Described are various embodiments of methods, systems and computer-readable mediums comprising instructions for registering respective digital representations of at least two interconnected layers of a multilayer dataset. In some embodiments, the digital representations are preprocessed before key features in one layer are used to register that layer with another layer. In some embodiments, one layer is reduced to key features or coordinates of key features to register that layer with another layer. One application disclosed is the assembly of a three-dimensional representation of an integrated circuit from two-dimensional representations of respective integrated circuit layers and specifically, from high-definition images of respective integrated circuit layers.

### RELATED APPLICATION

The instant application is related to and claims the benefit of priority to Canadian Patent Application serial number CA 3,198,323, entitled “REGISTERING DIGITAL REPRESENTATIONS OF INTERCONNECTED LAYERS OF MULTILAYER DATASETS” and filed May 1, 2023, the contents of which are hereby incorporated by reference in their entirety.

### FIELD OF THE DISCLOSURE

The present disclosure relates to registering digital representations of interconnected layers of multilayer datasets and in particular, to various embodiments of a method for registering respective digital representations of at least two interconnected layers of a multilayer dataset and various embodiments of a computer-readable medium comprising machine-executable instructions to enable such methods.

### BACKGROUND

Certain datasets are comprised of multiple distinct layers, which may be related either logically or physically. The processing of such datasets, for example to register related layers or otherwise track features through different layers, is typically performed manually, which is labour intensive and thus, expensive. Whilst electronic processing options are available, these are computationally intensive and thus, also expensive.

In some applications, the layers may comprise images of objects or environments. Registering or otherwise tracking features through layers comprising one or more images can be even more computationally intensive, particularly where images are of a high resolution, such as those captured by microscopy. Indeed, the distortion, noise, blurring, stretching or other image defects which inevitably exhibit in high resolution images detract from the quality thereof, such that processing of the layers (such as for image registration or feature tracking) becomes challenging, or indeed, such that increased processing power is required. Furthermore, large image sizes required to capture large amounts of data can result in false or inaccurate image registrations, which if left unaddressed, undermine the purpose of such processing or if addressed, typically require human intervention.

One example of a dataset requiring computationally intensive processing is that of an integrated circuit (IC) dataset, which in some examples includes a plurality of images of layers of the IC. Processing the plurality of images of the IC layers is often encountered when engineers are attempting to reverse engineer the IC using only the physical IC. Another example of a dataset requiring computationally intensive processing is that of a mapping dataset, which in some examples includes a plurality of map layers representative of a particular environment and/or features in that environment (for example, geological data, street data, traffic data, park data, et cetera).

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concept(s) described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for methods, systems and related computer-readable mediums for registering respective digital representations of at least two interconnected layers of a multilayer dataset that overcome some of the drawbacks of known techniques, or at least, provide a useful alternative thereto. Some aspects of this disclosure provide examples of such methods, systems and related computer-readable mediums.

In accordance with one aspect, there is provided a method for registering respective digital representations of at least two interconnected layers of a multilayer dataset. The respective digital representations at least partially correspond with a common region shared between the at least two interconnected layers. The method is automatically executed by at least one digital data processor and comprises: receiving as input the respective digital representations of at least a first layer and a second layer of the multilayer dataset, the respective digital representations comprising location data of interlayer connective features and intralayer connective features; calculating a correlation profile between the respective digital representations in accordance with a correlation function based, at least in part, on an alignment between digital coordinates associated with the interlayer connective features present in the first layer and the intralayer connective features present in the second layer; and identifying a profile feature in the correlation profile to, at least in part, inform registration of respective digital representations which reflects at least logical interconnectivity between the first layer and the second layer.

In one embodiment, receiving as input the respective digital representations comprises receiving segmented digital representations of any one or both of the first layer and the second layer. In another embodiment, receiving as input the respective digital representations comprises receiving digital images of the first layer and the second layer and the method further comprises segmenting the digital images to provide segmented digital representations of any one or both of the first layer and the second layer.

In one embodiment, calculating the correlation profile comprises identifying one or more related data layer feature locations associated with said interlayer connective features in a segmented digital representation of the first layer.

In one embodiment, calculating the correlation profile further comprises determining a centroid for each of the one or more related data layer feature locations to provide the digital coordinates associated with the interlayer connective features.

In one embodiment, the correlation function comprises any one or both of shifting and/or stretching the digital coordinates associated with the interlayer connective features of the first layer with respect to the intralayer connective features of the second layer to calculate the correlation profile.

In one embodiment, the correlation function comprises a normalized cross-correlation.

In one embodiment, identifying the profile feature comprises identifying a maximum correlation in the correlation profile.

In one embodiment, identifying the maximum correlation in the correlation profile comprises selecting a median of a list of coordinates associated with any axis and applying normalized cross-correlation thereto.

In one embodiment, the method further comprises, prior to the calculating the correlation profile, applying a weighting function to any one or more of the respective digital representations so as to bias the calculating of the correlation profile.

In one embodiment, the weighting function comprises a blurring function.

In one embodiment, the method further comprises fragmenting any one or more of the respective digital representations into a grid of smaller tiles prior to the calculating of the correlation profile.

In one embodiment, the method further comprises increasing a size of a tile associated with the second layer to include a portion of one or more neighbouring tiles in the second layer. In this embodiment, calculating the correlation profile is based on a smaller tile from the first layer and a larger tile from the second layer, both corresponding to the common region.

In one embodiment, the logical interconnectivity between the first layer and the second layer corresponds with a spatial alignment between one or more of the interlayer connective features and one or more of the intralayer connective features.

In one embodiment, the multilayer dataset comprises an integrated circuit layer dataset and the digital representations comprise microscopy images of the at least two interconnected layers of an integrated circuit.

In one embodiment, the interlayer connective features comprise one or more vias and the intralayer connective features comprise one or more wires.

In one embodiment, the interlayer connective features comprise one or more vias, the intralayer connective feature comprises one or more wires, and segmenting the digital images comprises: segmenting the first layer based on representation of metal to identify the one or more vias; and segmenting the second layer based on representation of metal and dielectric to identify the one or more wires.

In one embodiment, the method forms part of a method for reverse engineering a layout of at least a part of an integrated circuit.

In accordance with another aspect, there is provided a computer-readable medium comprising machine-executable instructions which when executed, enable at least one digital data processor to execute the method as described in any one or more of the foregoing embodiments.

In accordance with a further aspect, there is provided a computer-readable medium comprising machine-executable instructions which when executed, enable at least one digital data processor to: receive at least a first digital representation of a first layer and a second digital representation of a second layer, wherein the first layer and the second layer comprise distinct stackable layers of a multilayer dataset; process the first digital representation of the first layer to characterize an interlayer connective feature represented therein; process the second digital representation of the second layer to characterize an intralayer connective feature represented therein; and determine an alignment between the first digital representation and the second digital representation based on the interlayer connective feature characterized from the first digital representation aligning with the intralayer connective feature characterized from the second digital representation.

In one embodiment, processing the first digital representation of the first layer to characterize an interlayer connective feature represented therein comprises any one of combination of: segmenting the first digital representation of the first layer to produce a segmented first digital representation; identifying one or more related data layer feature locations associated with the interlayer connective features in the segmented first digital representation; and determining a centroid for each of the one or more related data layer feature locations to provide digital coordinates associated with the interlayer connective features.

In one embodiment, determining the alignment between the first digital representation and the second digital representation comprises aligning digital coordinates associated with one or more centroids of the interlayer connective features with the intralayer connective feature of the second digital representation.

Features of any one aspect of the disclosure may be incorporated into any other aspect of the disclosure, and vice versa, without limitation. Other aspects, features and/or advantages will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a flow diagram of an exemplary method for registering respective digital representations of at least two interconnected layers of a multilayer dataset, in accordance with one embodiment;

FIG. 2 is a digital representation of a portion of an exemplary integrated circuit (IC) layer, indicating exemplary interlayer and intralayer features identifiable therein, in accordance with one embodiment;

FIG. 3 is a digital representation of a portion of an exemplary first IC layer, the digital representation being an originally captured image, in accordance with one embodiment;

FIG. 4 is a digital representation of a portion of an exemplary second IC layer, which physically abuts the first IC layer shown in FIG. 3, the digital representation again being an originally captured image, in accordance with one embodiment;

FIG. 5 is a digital representation of the portion of the second IC layer shown in FIG. 4, which specifically comprises a segmented image of the originally captured image to allow intralayer connective features to be more clearly identifiable or distinguishable therein, in accordance with one embodiment;

FIG. 6 is a digital representation of the portion of the first IC layer shown in FIG. 3, wherein the originally captured image is divided into a 4×4 grid defining 16 tiles for further processing, in accordance with one embodiment;

FIG. 7 is a digital representation of the portion of the second IC layer shown in FIG. 5, wherein the segmented image is divided into a 4×4 grid defining 16 tiles for further processing, in accordance with one embodiment;

FIG. 8 is a digital representation of an upper left tile (column 1, row 1) of the exemplary 4×4 grid shown in FIG. 6, thus reflecting a portion of the originally captured image of the first IC layer;

FIG. 9 is a digital representation of an upper left tile (column 1, row 1) of the exemplary 4×4 grid shown in FIG. 7, thus reflecting a portion of the segmented image of the second IC layer;

FIG. 10 is a digital representation of the upper left tile shown in FIG. 8, wherein the portion of the originally captured image of the first IC layer has been segmented to allow interlayer connective features to be more clearly identifiable or distinguishable therein, in accordance with one embodiment;

FIG. 11 is a digital representation of the upper left tile shown in FIG. 10, wherein the segmented image of the first IC layer has been contoured to identify or distinguish one or more related data layer feature locations associated with the interlayer connective features, and specifically to identify a boundary or contour associated with each of the interlayer connective features, in accordance with one embodiment;

FIG. 12 is a digital representation of the upper left tile shown in FIG. 11, wherein centroids of each interlayer connective feature have been identified in the contoured image of the first IC layer, as shown in the enlarged portion, such that digital coordinates for each centroid can be determined, in accordance with one embodiment;

FIG. 13 is a digital representation of the respective upper left tiles from the portions of the first and second IC layers overlaid over one another to visually reflect the operation of an exemplary method, wherein each layer is visualized in a distinct channel after resolving the shift, in accordance with one embodiment;

FIG. 14 is a digital representation of further exemplary tiles (not shown separately) from further portions of exemplary first and second IC layers overlaid over one another with a further exemplary method, wherein the step of identifying a correlation profile yields several local maxima, as illustrated by the offset nature of the dots or spots with reference to the blocks, in accordance with one embodiment;

FIG. 15 is a digital representation of same exemplary tiles from FIG. 14, overlaid over one another with a further exemplary method, wherein the step of identifying a correlation profile is performed by focusing on the median of the digital coordinate lists, in accordance with another embodiment, yielding the maximum correlation, as illustrated by the aligned nature of the dots or spots with the blocks (as compared to FIG. 14);

FIG. 16 is a digital representation of a reconstructed image of a portion of an exemplary first IC layer based on the coordinates calculated for centroids of vias, illustrating the accuracy of one embodiment of the method;

FIG. 17 is a digital representation of another portion of an exemplary first IC layer, the digital representation being an originally captured image having a 4×4 grid defining 16 tiles, with a middle tile (column 3, row 2) forming the search space in the first IC layer, in accordance with another embodiment;

FIG. 18 is a digital representation of another portion of another exemplary second IC layer, the digital representation being a segmented image having a 4×4 grid defining 16 tiles, with a middle tile (column 3, row 2) being enlarged by a certain factor to include portions of neighbouring blocks to form the search space in the second IC layer, in accordance with another embodiment;

FIG. 19 is a digital representation of the enlarged middle tile highlighted in the segmented image of FIG. 18 (forming the search space), in which intralayer connective features are identifiable or distinguishable, in accordance with one embodiment;

FIG. 20 is a digital representation of the respective middle tiles from the portions of the first and second IC layers shown in FIGS. 17 and 18 overlaid over one another after processing (i.e. resolving the shift) to visually reflect the operation of this exemplary method wherein one of the tile sizes is enlarged relative to the other, in accordance with one embodiment, yielding the maximum correlation as illustrated by the aligned nature of the dots or spots with the blocks;

FIG. 21 is an enlarged view of row 4 of the digital representation of the portion of the first IC layer shown in FIG. 6, having no or relatively few interlayer connective features, in accordance with another embodiment;

FIG. 22 is a graph of the exemplary fitting of a polynomial to exemplary shift values in the columns, showing the original values as circles, the L1-norm curve fitting as a one graph line and the L2-norm curve fitting as another line, in accordance with one embodiment;

FIG. 23 is a graph of the exemplary fitting of a polynomial to exemplary shift values in the rows corresponding to the columns of FIG. 22, showing the original values as circles, the L1-norm curve fitting as a one graph line and the L2-norm curve fitting as another line, in accordance with one embodiment;

FIG. 24 is an array of heat maps or contour plots of further examples of sliding each tile from the first IC layer on its corresponding tile from the second IC layer to find the extrema (specifically, maxima, in this example), in accordance with one embodiment of the method, illustrating that several local extrema can be obtained, which may impact layer registration and/or which may require further input or processing;

FIG. 25 is an array of heat maps or contour plots of further examples of sliding each tile from the first IC layer on its corresponding tile from the second IC layer to find the maxima, in accordance with another embodiment of the method wherein the search area is enlarged to take into account edge/boundary features and wherein the correlation function is focused on the median to find the extrema (specifically, maxima, in this example), illustrating that several local extrema can be eliminated to obtain a more sound layer registration or alignment;

FIG. 26 is a component diagram of an exemplary system for acquiring images of layers of an IC and registering such images to form or inform a three-dimensional (3D) representation of the IC, or a portion thereof, in accordance with another embodiment; and

FIG. 27 is a flow diagram of exemplary operation of the system shown in FIG. 26, illustrating the processing and information obtained for forming or informing the 3D representation of the IC, or a portion thereof, in accordance with one embodiment.

Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Various apparatuses and processes will be described below to provide examples of implementations of the system disclosed herein. No implementation described below limits any claimed implementation and any claimed implementations may cover processes or apparatuses that differ from those described below. The claimed implementations are not limited to apparatuses or processes having all of the features of any one apparatus or process described below or to features common to multiple or all of the apparatuses or processes described below. It is possible that an apparatus or process described below is not an implementation of any claimed subject matter.

Numerous specific details are set forth to provide a thorough understanding of the implementations described herein. However, it will be understood by those skilled in the relevant arts that the implementations described herein may be practiced without these specific details. In other instances, well-known methods, procedures and components have not been described in detail to not obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

It is understood that for the purpose of this specification, language of “at least one of X, Y, and Z” and “one or more of X, Y and Z” may be construed as X only, Y only, Z only, or any combination of two or more items X, Y, and Z (for example, XYZ, XY, YZ, ZZ, and the like). Similar logic may be applied for two or more items in any occurrence of “at least one . . . ” and “one or more . . . ” language.

Unless defined otherwise, all technical and scientific terms used herein have the same meaning as commonly understood by one of ordinary skill in the art to which this disclosure belongs.

Throughout the specification and claims, the following terms take the meanings explicitly associated herein, unless the context clearly dictates otherwise. The phrase “in one of the embodiments” or “in at least one of the various embodiments” as used herein does not necessarily refer to the same embodiment, though it may. Furthermore, the phrase “in another embodiment” or “in some embodiments” as used herein does not necessarily refer to a different embodiment, although it may. Thus, as described below, various embodiments may be readily combined, without departing from the scope or spirit of the innovations disclosed herein.

In addition, as used herein, the term “or” is an inclusive “or” operator and is equivalent to the term “and/or,” unless the context clearly dictates otherwise. The term “based on” is not exclusive and allows for being based on additional factors not described, unless the context clearly dictates otherwise. In addition, throughout the specification, the meaning of the singular forms “a,” “an,” and “the” include plural references unless the context clearly dictates otherwise. The meaning of “in” includes “in” and “on.”

The term “comprising” as used herein will be understood to mean that the list following is non-exhaustive and may or may not include any other additional suitable items, for example one or more further feature(s), component(s) and/or element(s) as appropriate.

In this specification, the term “digital representation(s)” refers to any digital representation of a layer, typically a layer of data, although not limited thereto, and may particularly refer to a digital representation of a layer which provides therein location data of certain feature or at least, from which such location data of certain features may be extracted. As the context will indicate, in various different embodiments, “digital representation(s)” may refer to any one or combination of: original digital image(s), segmented image(s), processed graphic representation(s) of images, binary code representative of image(s), digital coordinates representative of image(s), or the like, without limitation.

In this specification, the term “layer” may be used to refer to a full layer of an object or data layer, or otherwise may refer to a portion of such full layer (for example, an image of a portion of a layer or a subset of data representative of a layer), as the context may indicate and without limitation. The systems, methods and mediums disclosed herein may be equally applicable to a layer(s) of various dimensions and containing various data. In some embodiments, a layer may refer to the physical layers associated with a substrate being imaged, as well as the images thereof. In other embodiments, a layer may refer to a logical layer showing information or characteristics associated with a given physical layer being imaged; for example, an image or other graphical representation of streets or other types of pathways may have overlaid thereon, as a data layer, traffic density, or other travel-related information (for example, traffic speed, common routes, etc.). Moreover, different sensing techniques may obtain different types of information associated with a given physical layer (for example, optical sensors and particle impingement/detection); in such cases, the different information may be overlaid with one another and referred to herein as different layers.

In this specification, the terms “interlayer connective features” and “intralayer connective features”, respectively, are used interchangeably with the singular forms of each. Indeed, references to “connective features” are intended to include reference to a singular “connective feature”, particularly in embodiments where for example, a digital representation only includes a single connective feature, or where only a single connective feature is processed. Yet further, it is to be appreciated that, in some embodiments, any such connective feature(s) may be entirely absent from a digital representation, and the methods, systems and mediums disclosed herein may be applied thereto.

In this specification, unless the context indicates otherwise, the term “correlation” is used to refer to some association or relationship between objects (for example, features, images, profiles, data or the like), which in various embodiments may comprise a similarity, an alignment, a specified offset or the like, without limitation.

In most data processing, the size of data becomes a limiting factor with reference to processing power required, storage required, processing speed, or the like. These processing limitations are more pronounced when datasets are comprised of data items each having a large amount of data stored therein and/or extractable therefrom. High resolution images provide one example, where the images require large amounts of storage and processing capability, since the images themselves contain a large amount of data therein. Other examples may relate to datasets pertaining to geographical maps, dynamic traffic tracking or the like. Certain applications require high resolution images or other datasets to be reconstructed, aligned, stacked, stitched or otherwise overlaid over one another (herein collectively and interchangeably referred to as “registered” or suitable derivations thereof, although the context may indicate which form is intended), and sometimes many layers of images or datasets are to be processed for same. Thus, one challenge associated with the registration of datasets relates generally to the computational complexity involved. Another challenge, which relates directly or indirectly to computational intensity, is accuracy of the registration.

The systems, methods and mediums described herein provide, in accordance with different embodiments, different examples in which a three-dimensional (3D) representation or structure of a sample or object may be constructed or reconstructed (used interchangeably herein) based on two dimensional datasets. Accordingly, the systems, methods and mediums disclosed herein may be focussed on the registration of (distinct) layers of a multilayer dataset, so as to form or otherwise inform a 3D representation of same, or a portion thereof, in any direction. Some specific embodiments may aim to reduce the computational complexity and/or accuracy of same. Some embodiments may further facilitate the registration of layers by accommodating differences between distinct layers, such as distortion or different resolutions. Notably, the “layers” herein referenced may be logical layers, physical layers or the like, and may include at least two layers but are not limited thereto, and any number of layers may be registered in various embodiments.

In some embodiments, where the systems, methods and mediums disclosed herein are applicable to microscopy images, it is to be appreciated that the sample may be too large to fit into the field of view of the microscope. Thus, in such embodiments, multiple overlapping images of a single layer may need to be captured to enable the registration of the whole image of the sample from the individual image stacks. In some embodiments, multiple images of multiple distinct layers may need to be captured to enable such registration of the whole sample, particularly in three dimensions. Automating the registration of multiple images, whether in a single plane or multiple planes, can be computationally challenging or intensive, and indeed, time-consuming and expensive. Such automatization may be further intensified when the size of the dataset to be registered is large, considering any one or both of the size of the images or layers themselves and/or the number of images or layers to be registered. Indeed, image-to-image comparisons may be prohibitively complex and, in some embodiments, may lead to false positives/negatives which impact the confidence level in registration and/or which require human intervention, which is time-consuming and thus, expensive. The systems, methods and mediums described herein may provide, in accordance with some embodiments, different examples in which the computational complexity of such registration is reduced from an image-to-image comparison to an image-to-data comparison. In some specific embodiments, the computational complexity may be reduced to a binary image-to-data comparison. In yet more specific embodiments, the computational complexity may be reduced to comparing a binary image of one layer to coordinates (x and y points) associated with one or more features in another layer, particularly where such features are known to be interconnective between the respective layers.

In some embodiments, continuing the above example of registering microscopy images, the systems, methods and mediums described herein may provide, in accordance with some embodiments, different examples in which the computational complexity thereof is reduced or at least partly ameliorated. In some embodiments, this may be achieved by implementing preprocessing steps which reduce the amount of data for processing, thereby accelerating calculations and/or increasing computational efficiency. This preprocessing data reduction may, in some embodiments, be based on knowledge of the sample or object to be registered. In particular, in some embodiments, this data reduction is specifically based on knowledge of one or more features which are shared between or which otherwise connect distinct layers of the sample or object. Based on these shared or interconnective features, the data for processing can be substantially reduced from images to smaller datasets (for example, coordinates). For example, as will be described in detail hereunder, in one embodiment related to integrated circuits, based on the knowledge of vias connecting various layers of the IC, original image data of one or more layers may be reduced to the vias themselves, and then reduced to centroids of the vias as single data points (having x and y coordinates). As such, computational complexity may be reduced by reducing high-definition images to data points reflecting certain shared or interconnective features in same for further processing. Notably, such data reduction steps may be applied to any number of images or layers in various embodiments.

In some embodiments, which may be employed in addition to or in the alternative to the above, computational complexity may be reduced or at least partly ameliorated by smoothing one or more objective functions, or otherwise applying a weighting function. In some embodiments, this may be achieved by implementing a blurring function to one or more of the images or layers, which is configured to ensure the border/edge of features in the images or layers being processed are considered using neighbouring features, thereby reducing the likelihood of finding matches with borders/edges of images or layers. For example, as will be described in detail hereunder, in one embodiment related to integrated circuits, the border/edge of image components (for example, vias and wires) in one image from one layer may be blurred using neighbouring pixels, making the objective function smoother and reducing the likelihood of matches with the border/edge of another image from another layer. As such, smoothing the objective function provides an alternative or additional means of reducing computational complexity in some embodiments, and/or otherwise improving accuracy.

In some embodiments, reducing computational complexity and/or improving accuracy may be at least partly achieved by reducing image or layer sizes or specifically, reducing images or layers into respective grids of tiles which can be independently processed (for example, tile 1 from layer 1 and corresponding tile 1 from layer 2) to seek the registration. Indeed, reducing the size of data under consideration under any stage of processing may not only reduce computational complexity, but may further improve accuracy, particularly where each tile comprises a significant amount of data on its own.

In some embodiments, continuing the above example of registering microscopy images, the systems, methods and mediums described herein may provide, in accordance with some embodiments, different examples in which the accuracy thereof is improved. Such embodiments may be particularly useful where, for example, several local maxima are obtained (or minima, as the case may be), potentially leading to an incorrect solution for the registration. In some embodiments, improving accuracy may be at least partly achieved by focusing correlation searching on a statistically center measurement, such as a median, to exclude outliers or the like which may otherwise impact the accuracy in finding the match between the layers or images. In some embodiments, improving accuracy may be at least partly achieved by increasing the search space under consideration, in at least one of the layers or images being registered, particularly where, for example, preprocessing involved splitting the original data into portions to reduce computational complexity (here, “splitting” need not refer to physical splitting into portions, but may refer to defining respective portions in the original data as independent search spaces by, for example, applying a grid thereto).

Each of these beneficial aspects or advantages of the instant disclosure will be further described with reference to specific examples below. It is to be appreciated that these aspects or advantages may be implemented concurrently or independently in different embodiments, as the context may indicate, and that the benefits discussed may be of independent or confounding impact, in different embodiments. Furthermore, as noted elsewhere, although these aspects or advantages are specifically described herein with reference to images, it is to be appreciated that the same inventive concepts may be equally or adaptively applicable to other multilayer datasets, including for example, geographic data forming part of a geographical information system mapping various data types to a map, without limitation.

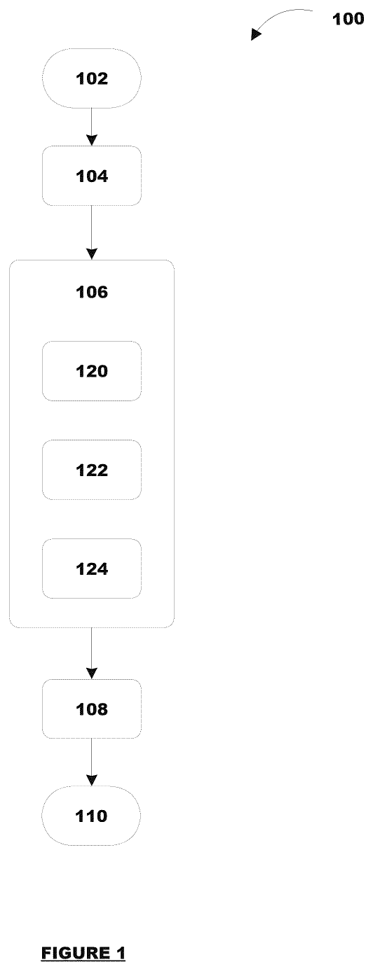

With reference now to FIG. 1, and in accordance with one exemplary embodiment, a method for registering respective digital representations of at least two interconnected layers of a multilayer dataset (hereinafter “method”), generally referred to using reference numeral 100, will now be described. The method 100 starts at 102 and is automatically executed by at least one digital data processor. In this embodiment, the respective digital representations at least partially correspond with a common region shared between the at least two interconnected layers. More specifically, in this embodiment, the common region comprises at least a portion of an area which is vertically shared between the at least two interconnected layers, although other embodiments are not limited thereto. Notably, the at least two interconnected layers may represent physically stacked or stackable layers, or otherwise may represent spaced apart layers (having intervening layers between them) which are still interconnected by one or more interlayer connective features, as described below. In such contexts, the “common region” typically refers to some shared vertical plane of the respective layers, the layers each having a portion which is vertically overlapping with one another, although perfect or complete overlap is not necessary. In some embodiments, the common region or vertically shared region may be known, whereas this vertical relationship may be unknown in other embodiments. Furthermore, in some embodiments, the common region may comprise the whole tiles or layers, as the case may be, whereas in other embodiments, only a portion of tiles or layers may be in common. The common region is not typically a specific region of a tile or layer (or example, a predefined region of interest), although it may be so.

At 104, the method 100 comprises receiving as input the respective digital representations of at least two layers of the multilayer dataset and specifically in this embodiment, digital representation of a first layer and a second layer. It is to be appreciated that, whilst the first and second layers are used here for exemplary purposes, the multilayer dataset may comprise a plurality of layers. The respective digital representations received comprise location data of interlayer connective features and intralayer connective features which are identifiable from the first layer and the second layer. As used herein, the “interlayer connective features” are those features which connect two or more distinct layers of the multilayer dataset. The interlayer connective features may be physical connections between layers, or logical connections between layers, without limitation. In contrast, as used herein, the “intralayer connective features” are those features which are present in a single one (or more layers), but which are not used to physically or logically connect distinct layers. Simply put, the interlayer connective features may traverse over two or more layers, whereas the intralayer connective features are confined to a single layer (although may be found on various distinct layers).

In this embodiment, receiving 104 as input the respective digital representations specifically comprises receiving original digital images of the first layer and the second layer. In this particular embodiment, the first layer and the second layers are specifically portions of layers of an integrated circuit (IC), with the multilayer dataset comprising a plurality of original digital images taken of respective layers of the IC. Notably, whilst single images of each layer are used herein for exemplary purposes, each layer of the multilayer dataset may comprise thousands of images (or tens of thousands) so as to capture or represent the full layer. Indeed, in this embodiment, the first and second IC layers physically abut one another within the IC (i.e. one is on top of the other, although other embodiments are not limited thereto) and as is the nature of ICs, may share features between these distinct layers. As the dimensions of IC features are typically relatively much smaller than the dimensions of the area of the IC, often on the nanometer scale or even smaller, versus on the millimeter scale of an IC, the original digital images of the first and second layers received 104 are of a high resolution (specifically, 8K×8K images in this example, approximately 64 MP), so as to capture the features and connectivity present or identifiable from each layer or that specific portion of each layer. Even at such high resolution, a large number of images are required across each layer (in both x- and y-directions) so as to capture or represent the full layer and therefore, in some embodiments, stitching or other methods may be employed to logically assemble the images of each layer, although the images from respective layers can be employed without such logical layer assembly in some embodiments. Notably, other resolutions and/or input data sizes may be workable in other embodiments.

In this specific embodiment, since the sample comprises an IC, the interlayer connective features comprise one or more vias and the intralayer connective features comprise one or more wires, although other features may be workable in different embodiments. Generally, vias comprise small openings in the insulating semiconductor layer, typically filled with copper, tungsten or other metal(s), which allow conductive connection between different layers of the IC, whilst wires are used to make interconnections or form the circuitry between devices or components of the IC, typically mostly within a single IC layer. Notably, whilst these features (vias as interlayer connective features and wires as intralayer connective features) may be visible under scrutiny of the original digital images, further computational processing further identifies or distinguishes same, as herein described, and indeed is necessary when large amounts of images or layers, or otherwise high-resolution images or layers, are to be processed for registration.

In this embodiment, receiving 104 as input the respective digital representations further comprises segmenting the original digital images to provide segmented digital representations of the first layer and the second layer. More specifically, the original digital images are segmented based on pixel intensity in this embodiment, using thresholding. In this embodiment, segmenting the original digital images to provide the segmented digital representations may aid in the identification or location of the vias and wires (as the interlayer connective features and the intralayer connective features, respectively). Put differently, segmenting the original digital images to provide the segmented digital representations may reduce the noise or other, less relevant componentry, in the images, to simplify the images for further processing. In this embodiment, the segmenting generally simplifies the varying pixel intensities in the original digital images to binary pixel intensities in the segmented digital representations, facilitating identification or location of the features present in each layer. This may be particularly useful in reducing the computational power required for further processing, as herein described.

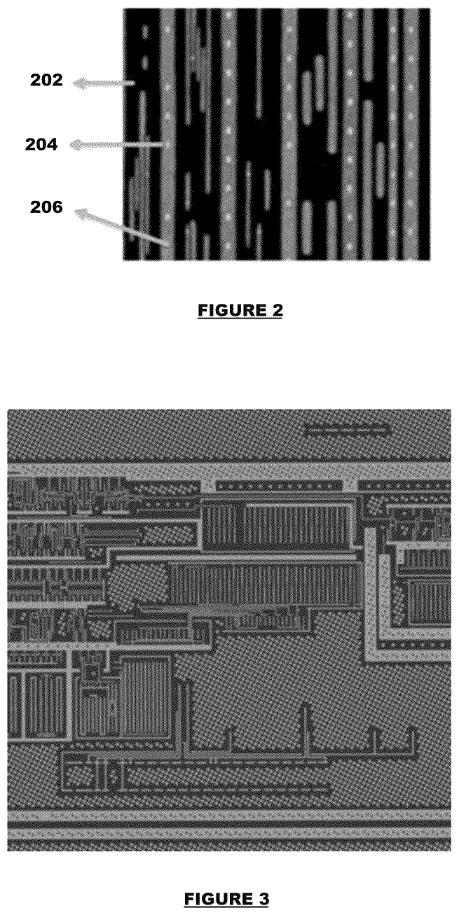

In this embodiment, as alluded to, the original digital images (for example, scanning electron microscope images) are segmented to locate or distinguish between known componentry of the respective IC layers, and specifically in this embodiment, including the metal components and dielectric components (such as silicon dioxide). Indeed, in this embodiment and as shown in FIG. 2, which is the original SEM image of a portion of an exemplary IC layer, vias 204 (being interlayer connective features), wire 206 and dielectric 202 (both 206 and 202 being intralayer connective features) are identifiable therein. In this digital representation, the dielectric 202 is visible as the darkest-intensity colour (black), since the dielectric does not include metal (the dielectric may comprise, for example, silicon dioxide); the metal wires 206 are visible as the medium-intensity colour (grey), since the metal wires are under a layer of dielectric; and the vias 204 are visible as the lightest-intensity colour (white) as the metal vias are exposed as they traverse through the plane/layer to connect different layers. These characteristics or features of the original digital images may be exploited, in this embodiment, through segmentation, to further locate specific features of interest. In this embodiment, as noted, the features of interest include the vias and wires (as the interlayer connective features and the intralayer connective features, respectively), and therefore segmentation may remove the representation of the dielectric from the representation(s) to simplify same for further processing.

Thus, in summary and based on the foregoing, in this embodiment, receiving 104 specifically comprising receiving the original images and segmenting the images.

At 106, the method 100 comprises calculating a correlation profile between the respective digital representations in accordance with a correlation function (sometimes referred to as a similarity profile and/or similarity function). In this embodiment, the correlation function is based, at least in part, on an alignment between digital coordinates associated with the interlayer connective features (vias) from the first layer and intralayer connective features (wires) identifiable in the second layer. Accordingly, this embodiment of the method 100 provides for the comparison and/or alignment of digital coordinates from the first layer (specifically of the vias as interlayer connective features) with the segmented image from the second layer (specifically of the wires as intralayer connective features). Notably, the segmented image of the second layer is available from step 104, but further processing of the first layer is required to provide the digital coordinates of the vias for calculating 106 the correlation profile. Thus, the step of calculating 106 the correlation profile between the respective digital representations, in this embodiment, includes several sub-steps. Each of these sub-steps is described next, with the understanding that other embodiments may deviate from these sub-steps, having different or alternative steps, another order, or the like.

In this embodiment, calculating 106 the correlation profile comprises at 120, identifying one or more related data layer features (for example, pixels in embodiments using an image of a layer) sharing similar or the same magnitude of the segmentation representation (for example, pixel intensity), or having a spatial relationship therewith (for example, the interior of a “ring” of high intensity pixels) associated with the interlayer connective features in the segmented digital representation of the second layer; for example, in the case of a segmented image of interlayer connective features in the second layer, similar pixel intensities associated with a via, which may be visually identifiable in a segmented image, would be identified as, in some embodiments, a solid circle, ring, or other shaped area that is representative of a location of the ring-shaped boundary of the via (i.e. the interlayer connective feature in this example) which may then be relied upon for determining connectivity. The foregoing may be referred to herein as “contouring”. Specifically, the one or more related data layer features are identified as the location of the vias in this exemplary embodiment. As such, the step of contouring 120 the segmented image of the second layer involves identifying an outline or contour which encircles or which otherwise bounds the shape or form of the vias (if any) in the segmented image of the second layer. Indeed, the step of contouring 120 may be considered simple curve joining the continuous points along the boundary of the vias, and specifically in this embodiment, based on the pixel intensity. In this embodiment, since the first layer is represented as a binary image (shown in later examples), the vias to be found are shown as white components, whereas the remaining background (wires, dielectric) is shown in black, facilitating the contouring 120 based thereon. Notably, in this embodiment, the output of the contouring 120 returns a modified image in which the one or more contoured locations are indicated (for example, circled; again, shown in later examples).

In this embodiment, calculating 106 the correlation profile further comprises at 122, determining a centroid for each of the one or more related data layer feature locations, contoured or otherwise, to provide the digital coordinates associated with the interlayer connective features and specifically, the vias in this exemplary embodiment. As the one or more related data layer feature locations are identified, a centroid for each may be mathematically determined, and the coordinates thereof determined based on the size of the image (for example, based on pixel numeration in x and y directions). At 122, the method further includes storing the digital coordinates so determined for each via.

In this embodiment, calculating 106 the correlation profile comprises at 124, applying the correlation function to the data, and specifically to the digital coordinates associated with the interlayer connective features (specifically, the vias in this embodiment) present in the first layer with the intralayer connective features (specifically the wires in this embodiment) present in the second layer. Notably, as the digital coordinates of each via have been determined, applying the correlation function between the digital coordinates of the vias from the first layer and the binary image of the second layer is less computationally complex, particularly as compared to applying the same or a similar correlation function to the original image or even a segmented image from which the digital coordinates were extracted. Indeed, the correlation function in this embodiment is based on a data-to-image search for correlation (or simply put, measuring similarity), and specifically coordinate data to binary image. In this embodiment, the correlation function comprises shifting the digital coordinates associated with the interlayer connective features (vias) of the first layer with respect to the segmented image of the second layer (and specifically, the intralayer connective features (wires)) so as to calculate the correlation profile. In this embodiment, at 124, the correlation function applied specifically comprises a cross-correlation, which measure similarity between the via coordinates of the first layer and wires in the segmented image of the second layer. More specifically, in this embodiment, the correlation function applied comprises a normalized cross-correlation (NCC). Once the correlation profile is determined using NCC, in this embodiment, the method 100 proceeds to 108.

At 108, the method 100 comprises identifying a profile feature in the correlation profile. In this embodiment, the profile feature is identified to, at least in part, inform registration of the respective digital representations which reflects at least logical interconnectivity between the first layer and the second layer. In this embodiment, the interconnectivity is also physical, as the vias traverse layers, but other embodiments may require only logical connectivity. In this embodiment, at 108, identifying the profile feature specifically comprises identifying an extremum (or extrema) in the correlation profile and more specifically, a maximum correlation in the correlation profile in this embodiment. Indeed, in this embodiment, the maximum correlation in the correlation profile corresponds with the best alignment or registration between the digital representations of the respective first and second layers, based on the interlayer connective features in the first layer and the intralayer connective features in the second layer. Although the first and second layers do not specifically need to be registered, the profile feature in this embodiment reflects the best match or alignment between the first and second layers, based specifically on the via(s) in the first layer and the wire(s) in second layer, and can thus be stored for further processing and/or future registration. In some embodiments, the first and second layers may be registered based on this profile feature, optionally together with a plurality of other layers, so as to reconstruct a 3D representation of the IC or a portion thereof.

In this embodiment, when method 100 encounters for example, several local maxima in the correlation profile (for example, when identifying the maximum correlation in the correlation profile), the method 100 may further include, at 108, selecting a statistical center of the list of coordinates associated with one or both axes of the first layer (thus focussing thereon) and applying NCC thereto. Also in this embodiment, when method 100 encounters for example, several local maxima in the correlation profile, the method 100 may further include, at 108, increasing a size of a digital representation (image) associated with the second IC layer to include a portion of neighbouring digital representations (images) in the second layer, such that the correlation profile is calculated 108 based on a smaller image from the first IC layer and a larger image from the second IC layer, both corresponding to the common region. Both of these optional steps at 108 are described in detail further below, with reference to other examples.

Notably, in the method 100, the logical interconnectivity between the first IC layer and the second IC layer corresponds with a spatial alignment in this embodiment, and specifically between the interlayer interconnective features in the first IC layer (specifically, vias) and the intralayer connective features in the second IC layer (specifically, wires). Indeed, as will be appreciated by skilled artisans, vias are the devices or structures used to connect wires on various layers of the IC, and therefore there is a spatial alignment of layers which can be extracted or deduced from the vias and wires in each distinct layer of a common region. Notwithstanding same, other embodiments may differ, and the logical interconnectivity between layers may be purely logical, as opposed to being supported by physical connectivity, as is the case here.

In this embodiment and as alluded to, the multilayer dataset specifically comprises an IC layer dataset and the digital representations specifically comprise microscopy images of the at least two interconnected layers of the IC. Notably, the method 100 may be carried out in respect of the first and second layers only, or in respect of any number or combination of layers of the dataset. These layers may be considered stackable or overlayable, based specifically on shared or interconnective features between the distinctive layers. In this embodiment, the method 100 is used as an image registration method, whereby images of the IC are registered to construct a 3D or stacked representation of the IC, or otherwise simply to gather the registration data to perform same. In other embodiments, such image registration may be supplemented by other complementary image registration techniques, such as feature recognition, stitching or the like.

At 110, the method 100 ends. It is to be appreciated, however, that various alternative embodiments of the method 100 are envisaged, as well as various alternative embodiments of reducing the data load for processing and/or calculating 106 the correlation profile, without departing from the general nature and scope of the instant disclosure. Some of these embodiments or variations are briefly described hereunder, without limitation.

In other embodiments, receiving 104 as input the respective digital representations may comprise receiving any number of digital representations, which may be processed simultaneously or consecutively, in groups of twos or in groups of any number. In other embodiments, receiving 104 as input the respective digital representations may comprise receiving respective segmented digital representations of any one or both of the first layer and the second layer. Indeed, the layers may be segmented or otherwise preprocessed before being received 104 as input in the method 100.

In other embodiments, the first and second layers (whether IC layers or otherwise) need not physically abut one another. Indeed, in some embodiments, the first and second layers may be spaced apart or otherwise separated by other intervening layers, the first and second layers at least sharing one interlayer connective feature in the common region for which the correlation profile can be determined.

In other embodiments, any one or both of the first and second layers may be segmented based on other characteristics or computed properties of the layers, which may vary based on layer type or otherwise the connective features to be identified therein. In the context of images, for example, one or more images of the layers may be segmented based on colour, intensity or texture, to name but a few examples. In other embodiments, instead of threshold-based segmentation, canny edge detection may be employed.

In other embodiments, where the digital representations comprise colour images or features, for example, the contouring 120 of the first layer may be based on pixels having the same colour, as opposed to intensity. In other embodiments, one or more related data layer feature locations may be interchangeably referred to as “areas” and/or “blobs”, and/or, to the extent contouring has been applied, “contours”, and/or “contoured locations”. In this exemplary embodiment, the foregoing may refer to a group of connected pixels in an image sharing a common property (for example, intensity or colour). Indeed, various contouring functions or processes may be employed in different embodiments, to identify or locate key features; for example, the interior of a ring of pixels sharing the same or similar intensity or colour, may be contoured to form part of the same “blob” or “area” and, indeed, other spatial arrangements may be used as well, such as adjacency or proximity to the pixels sharing the value of interest. It is to be appreciated that, in some embodiments, the term “contouring” may be used to refer to identifying certain structural or conceptual outlines of objects in images or related data, and in some embodiments, contouring may include demarcating such outline(s) in images or related data. Furthermore, in other embodiments, the term “contouring” may be used to refer to identifying an area or region associated with objected in images or related data, and contouring may include labeling such area or region without demarcating an outline/contour or the like. Put differently, in different embodiments, “contouring” may refer to identifying contours or outlines of objects, and/or identifying areas or regions of objects. Indeed, any one or both may be employed to ultimately identify the location of the interlayer connective features (vias) and in turn, coordinates associated with such location.

In other embodiments, calculating 106 the correlation profile between the respective digital representations may be based on, digital coordinates, areas or contours associated with features in both the first and second layers (not just the first layer). Indeed, such embodiments may further reduce the amount of data requiring processing downstream and/or the amount of data on which to apply the correlation function.

In other embodiments, the correlation function may comprise any correlation function which considers spatial arrangement of variables, although typically a form of cross-correlation. In other embodiments, the profile feature may be another correlation profile which indicates high correlation but which is not the maximum, such as, for example, a minimum correlation, or otherwise where an expected offset is known or to be applied to a maximum or minimum. Indeed, in various embodiments, various extrema (or extremum) may be employed depending on the correlation function employed.

In other embodiments, the method 100 may further comprise fragmenting any one or both of the respective digital representations into a grid of smaller tiles, which may typically occur any time prior to calculating 106 the correlation profile. In one embodiment, fragmentation grids of similar shape and/or dimensions may be applied equally to the respective digital representations (of the first and second layers), such that corresponding tiles of each respective digital representation correspond at least in part to the common region. Indeed, smaller tiles may be used for the method 100, to further reduce computing power required at any given stage. In some embodiments, when method 100 encounters for example, several local maxima in the correlation profile determined for a specific tile pair, the method 100 may further include increasing a size of a tile associated with the second layer to include a portion of one or more neighbouring tiles in the second layer (for example, half of each neighbouring tile); such that the correlation profile is calculated based on a smaller tile from the first layer and a larger tile from the second layer, both corresponding to the common region. A non-limiting example hereof will be later described. Notably, whilst reference is here made to “fragmenting”, such fragmenting may refer to limiting the search space within the image to a smaller tile portion (and not physically fragmenting the image). In other embodiments, the method 100 may fragment any one or both of the first and second layers (whether segmented or not) into any number of tiles with any shape and/or dimensions.

In other embodiments, the method 100 may further comprise applying a weighting function to any one or more of the respective digital representations. In some embodiments, the weighting function may be applied to any one or more of the respective digital representations prior to the step of calculating 106 the correlation profile. In some embodiments, the weighting function may be employed so as to bias the results of the step of calculating 106 the correlation profile, such that a preferred or useful profile feature can be identified therefrom. To provide one non-limiting example, the weighting function may be applied to any one or more of the respective digital representations to bias the correlation profile calculated towards a center of one or more objects identified therein.

In other embodiments, the weighting function may comprise any one or more of: a blurring function, a convolutional filter, a median filter, an impulse function, a skeletonization function, a structural morphology function (for example, progressively narrowing objects until 1 pixel in the middle remains), or the like. In one embodiment, the weighting function may comprise a Fourier transform and/or a Gaussian filter, which biases the correlation profile such that the profile feature (maxima or minima) is found at a center of one or more objects (for example, wires or vias) identified. In other embodiments, for example one using a skeletonization function, may bias the correlation profile such that the profile feature (maxima or minima) is found at one side of one or more objects (for example, wires or vias) identified.

In some embodiments, the weighting function may specifically comprise a blurring function. In some embodiments, applying the blurring function may accommodate features located proximate to edges/borders of the one or more of the respective digital representations (or put differently, the blurring function may be configured to accommodate portions of features located at the edges/border of one or more of the respective digital representations). In some embodiments, applying the blurring function to one or more of the digital representations (for example, from separate layers) may ensure that the border/edge of features in the layers are considered using neighbouring features. For example, in embodiments where the digital representations comprise images, the blurring function may consider certain pixels associated with interlayer connective features in consideration of neighbouring pixels, to smooth out or more evenly identify the interlayer connective features. Accordingly, in some embodiments, applying the blurring function may reduce the likelihood of finding matches with borders/edges of layers, which may include only portions of features. In some embodiments related to ICs and microscopy images, the border/edge of image components (for example, vias and wires) in one layer may be blurred using neighbouring pixels, making the objective function smoother and reducing the likelihood of matches with the border/edge of another layer. Such blurring may facilitate the identification of a centroid. For example, in some embodiments, blurring may even out the shape of features (for example, vias) so as to provide a more regular shape for determining the centroid where otherwise, the related data feature location identification, which may include contouring of related data feature locations, would reveal a shape that is non-circular or otherwise irregularly shaped. As such, in some embodiments, applying the blurring function to any one or more of the respective digital representations may smooth the objective functions.

In various embodiments, the method 100 may apply the blurring function to one or more of the original digital representations, the segmented digital representations, the fragmented digital representations, the layers or the like, without limitation. Indeed, the blurring function may be applied at several different stages of the method, and/or may be applied more than once to different digital representations or the same digital representation at different stages. In one specific embodiment, the method may comprise applying a blurring function to the segmented image of the second layer so as to accommodate any features present along the border or edges thereof. In one specific embodiment, the blurring function comprises taking the Fourier transform thereof and applying a Gaussian filter thereto. Indeed, in this specific embodiment, the Gaussian filter may tend to favour the center of objects as opposed to edges. As such, in some embodiments, the blurring function may yield a smoother objective function, taking into account neighbouring pixels of components.

In some embodiments, the blurring function may to some extent accommodate differences between layers known to interconnect either logically or physically. For example, continuing the example of IC layers, differences between high resolution images of respective IC layer may differ due to distortion, thermal drift, different resolutions being used, or different ion beams being used, to list but a few examples. In such embodiments, the blurring function may ensure that the remainder of the method 100 or specific steps thereof (such as identifying a profile feature) are not negatively impacted by imaging artifacts or image attributes differing between layers.

In other embodiments, “digital representation(s)” may also or alternatively refer to a group of images, for example, that may be logically assembled into a grid, a single image or the like, and which may, for example, be registered with another image or group of images from another layer, without limitation. Indeed, the systems, methods and mediums disclosed herein are not intended to be limited to registration of a single image over another single image.

In other embodiments, the method 100 may carry out any one or more of the steps in parallel, or otherwise may carry out bulk preprocessing steps, for example, so as to accelerate processing time.

In other embodiments, the method 100 may be used to reconstruct a sample, object or the like of any dimensionality and/or in any direction, without limitation.

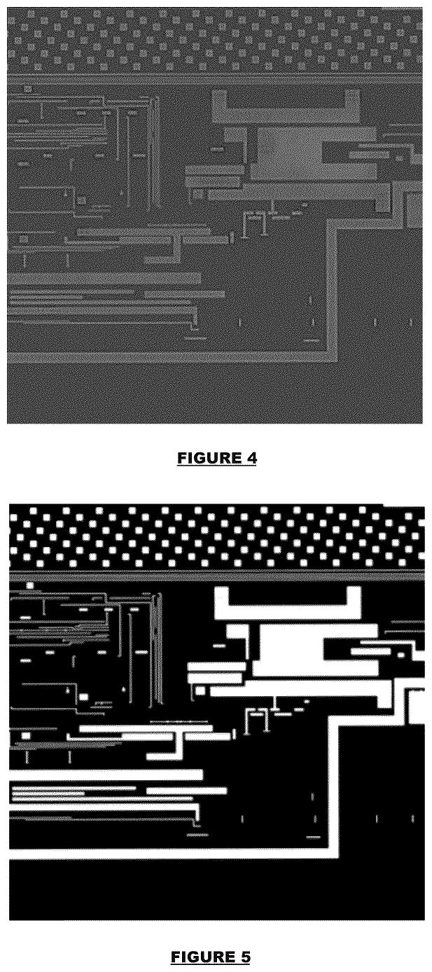

With reference now to FIGS. 3 to 13, one exemplary implementation of one embodiment of the method 100 for registering respective digital representations of at least two interconnected layers of a multilayer dataset will be described. This specific exemplary implementation is based on the respective digital representations shown in FIGS. 3 and 4, where FIG. 3 shows an originally captured image of a portion of a first IC layer (hereinafter “M1 layer”) and FIG. 4 shows an originally captured image of a portion of a second IC layer (hereinafter “M2 layer”). As mentioned previously, it is to be appreciated that these exemplary originally captured images may be two of thousands of originally captured images of the IC. Furthermore, these thousands of originally captured images forming the multilayer dataset may be stored in layers or groups corresponding to IC layers, or otherwise may be bulk stored prior to processing. In this embodiment, both the M1 layer and the M2 layer comprise 8K×8K scanning-electron microscopy images, thus being of high resolution. In this particular embodiment, the first and second IC layers abut one another in the IC structure in a vertical direction (although other embodiments are not limited thereto) and the original images have been acquired by a scanning electron microscope during an IC etching method, for example. Notably, the IC etched, imaged and eventually registered in this embodiment has an unknown structure or unknown connectivity, but the method 100 may facilitate in determining same or at least, form a part of determining same.

In this embodiment, the method 100 first comprises segmenting the M2 layer (i.e. FIG. 4) so as to identify or distinguish the intralayer connective features (if any) present therein. In this embodiment, the segmenting of the M2 layer is based on the metal portions of the IC layer (or more specifically, the portion thereof under analysis), and the output of such segmentation is the segmented image shown in FIG. 5 (hereinafter “M2 segmented layer”). Although the M2 segmented layer shown in FIG. 5 has the same number of pixels as the original image shown in FIG. 4, in this embodiment, it is to be appreciated that the segmentation applied, based predominantly on pixel intensities in this embodiment, simplify the layer “content” into something more manageable to analyze further. Notably, the M1 layer is not segmented at this stage, nor in this manner, in this embodiment, but instead remains as the M1 layer of the original image for the time being.

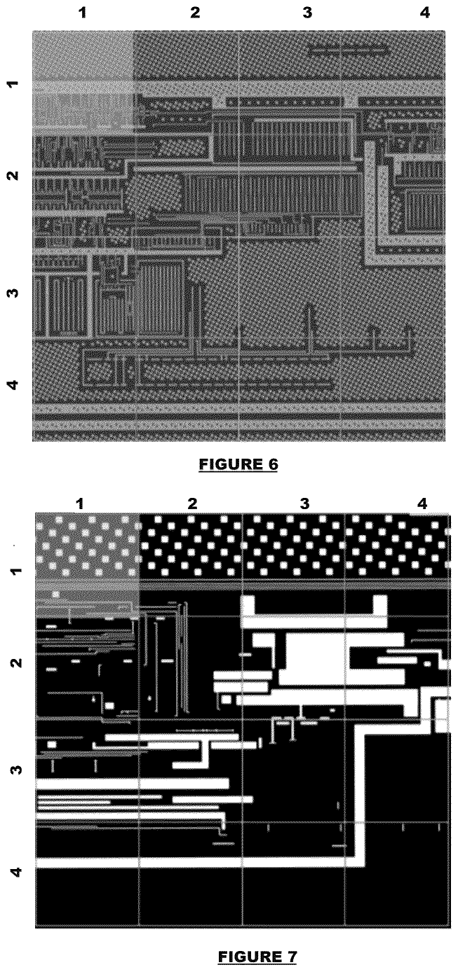

In this embodiment, the method 100 next fragments the M1 layer and the M2 segmented layer, respectively, each into corresponding 4×4 grids of 16 corresponding tiles, as shown in FIGS. 6 and 7, respectively. Notably, “fragmenting” in this context is referred to the division of the layers/images into tiles or smaller search spaces and is not intended to impart any randomized meaning thereto, nor indeed is any permanent separation necessary. The tiles in both the M1 layer and the M2 segmented layer, in this embodiment, have the same shapes and dimensions, as shown. This fragmentation or division of the layers into corresponding tiles allows the method 100, in this embodiment, to track or trace through corresponding tile pairs, one at a time or in parallel, so as to determine the correspondence profile for each pair to eventually inform alignment or registration of the images (on a tile level and/or on a layer level). In this embodiment, as shown by the lighter shaded upper left tile in both FIGS. 6 and 7 (column 1, row 1), the method 100 selects the first tile with which to proceed. The remainder of this exemplary implementation will be described with reference to this tile pair; however, it is to be appreciated that the method 100 would typically be implemented for the remaining tiles of the grid in turn, so as to inform the eventual alignment or registration of the images on a layer level, or at least, for a selection of tiles where the confidence level is sufficient for eventual alignment or registration.

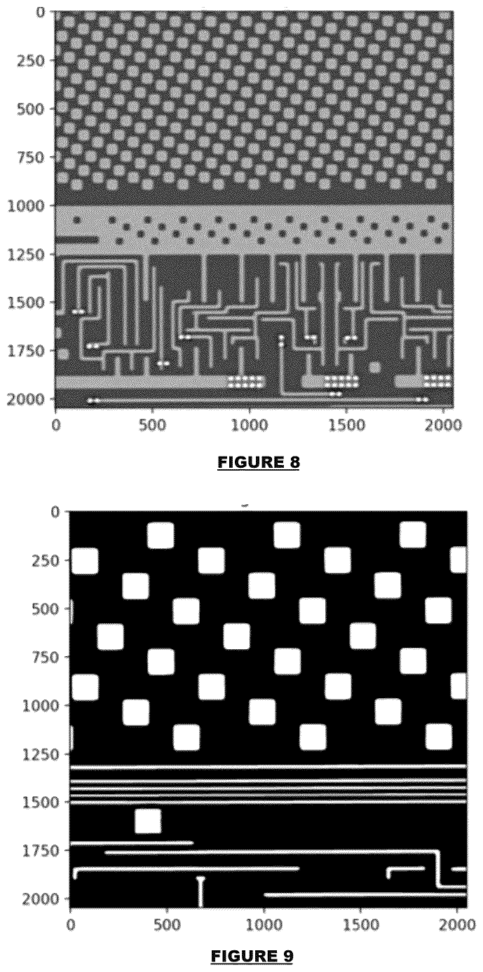

In this embodiment, as mentioned, the method 100 next selects a first tile of the M1 layer (original) and the M2 segmented layer (metal segmented). Any first tile may be selected as the starting point but in this embodiment, the method 100 selects the upper left tile of the respective layers, shown as the lighter shaded portion in FIGS. 6 and 7 (hereinafter the “M1 tile” and “M2 tile” respectively; collectively, “tile pair”). As such, the tile pair for further analysis is shown in FIGS. 8 and 9, with FIG. 8 showing the M1 tile and FIG. 9 showing the M2 tile. Selection of a single tile from each layer reduces the size of the digital representation for further analysis from the original 8K×8K resolution to 2K×2K resolution, in this embodiment. As shown, 2K×2K resolution nonetheless provides a large amount of data, which in this embodiment is specifically reflected in the image pixels.

In this embodiment, the method 100 now turns to processing the M1 tile further. In particular, in this embodiment, the method 100 comprises applying a blurring function (not specifically shown) to the M1 tile so as to accommodate any features present along the border or edges of the respective tiles. In particular, the blurring function in this embodiment ensures that where only portions of one or more vias (as the interlayer connective features) are present in the M1 tile under consideration, the blurring aids in later steps of contouring (or connected component identification) and determining centroids thereof.

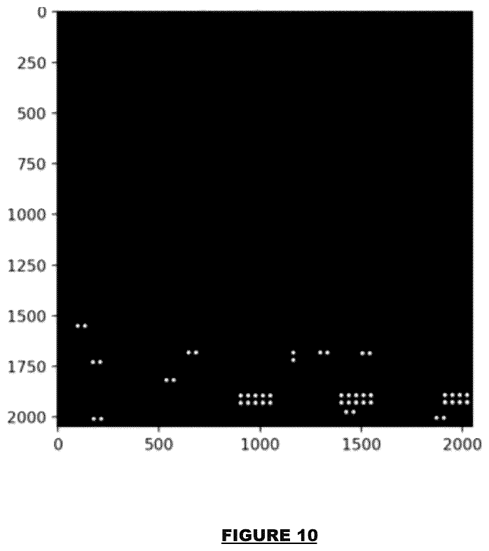

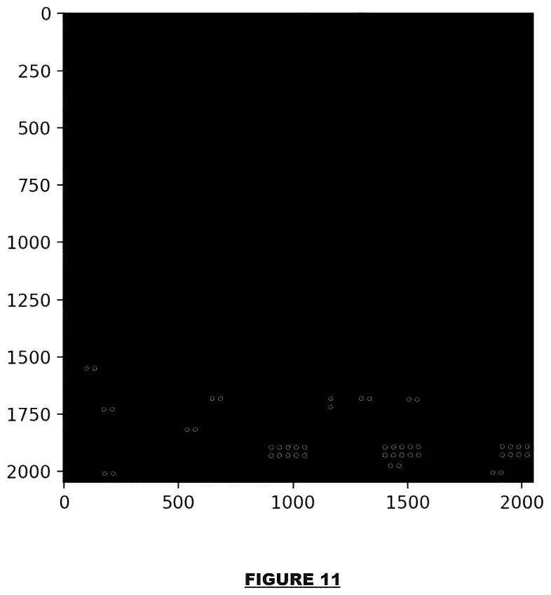

Next, the method 100 includes segmenting the M1 tile. In this embodiment, segmenting the M1 tile is based on the representation of metal in the M1 tile, after the blurring function has been applied thereto. In particular, in this embodiment, segmenting the M1 tile comprises thresholding the M1 tile so as to clearly identify or distinguish the vias (as the interlayer connective features) in the binary image output. The binary output of such segmentation of the M1 tile is the segmented image shown in FIG. 10 (hereinafter the “M1 binary tile”). As shown in FIG. 10, the vias of the M1 binary tile all appear to be located between 1500 and 2000 pixels in the y-axis. Although reference is made here to identifying or distinguishing the vias, it is to be appreciated that the specific location of the vias is yet to be determined at this stage in this embodiment, but general locations of vias are distinguished or otherwise made clearer by removing the background noise and/or features (i.e. wires and dielectric) that are not specifically considered relevant (for example, compare the M1 tile in FIG. 8 compared to the M1 binary tile of FIG. 10).

In this embodiment, the method 100 further comprises contouring the M1 binary tile of FIG. 10, to identify or distinguish one or more contoured locations of the vias (as the interlayer connective features). In this embodiment, contouring the M1 binary tile specifically comprises curve joining all the continuous points along the boundary or edge of each instance of via (as the interlayer connective features), having the same colour or intensity. In this embodiment, the contouring is based specifically on the intensity of the pixels identified as being vias through segmentation. As shown in FIG. 11, in this embodiment the output of the contouring of the M1 binary tile is a modified image (hereinafter the “M1 contoured tile”), in which the one or more contoured locations specifically provide or indicate the boundary or contour associated with each via present. Indeed, the step of contouring the M1 binary tile may provide, in this embodiment, useful information for via detection/recognition and/or via shape analysis. As shown, the one or more contoured locations of the vias in this embodiment specifically comprise a plurality of separated circular locations, having several pairs of vias and several larger groupings of parallel rows of vias, all between 1500 and 2000 pixels in the y-axis. Notably, the M1 contoured tile in this embodiment, as a modified image showing contoured locations, thus remains at 2K×2K size.

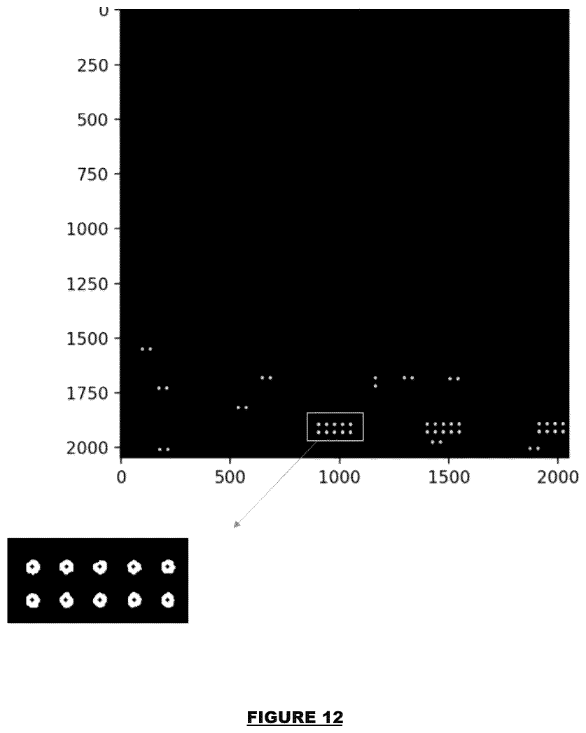

In this embodiment, the method 100 further comprises determining a centroid for each of the one or more contoured locations of the vias, to provide the digital coordinates associated with each via (as the interlayer connective features). The centroid in this embodiment defines the geometric center of each contoured location (or contour or blob) of vias, although in other embodiments offsets from geometric centers or other location identifiers may be used. Indeed, it is to be appreciated that this centroid determination is in a single plane based on the arithmetic mean position of all the points in the contoured location determined and thus that determining centroids does not account for mass, as such, in this embodiment. Determining the centroid of each contoured location of vias may be implemented by a mathematical function, for example being determined by: a plumbline method, a balancing method, a geometric decomposition, an integral formula, a formula for a bounded region, with an integraph, with a formula or formulae for specifically expected shapes, or the like. As shown in FIG. 12, the output of determining the centroid for each contoured location of each via is shown in the “M1 centroid tile”, wherein the enlarged portion more clearly illustrates the centroids so determined. As shown in the enlarged portion, the contoured locations may not be perfectly geometric, and therefore the mathematical function implemented for determining the centroids should account for any such irregularity in shape. Notably, in this embodiment, the M1 centroid tile is again a modified image showing centroids, and thus remains at 2K×2K size.

Once the centroids for each of the one or more contoured locations of the vias have been determined, the method 100 (either concurrently therewith or thereafter), calculates the digital coordinates associated with each centroid of each via. Notably, these coordinates may be based on the size of the image, and thus pixel numeration, or may be based on any other coordinate system suitable to the specific implementation. The method 100 further comprises storing these digital coordinates so calculated, thereby reducing the 2K×2K resolution M1 centroid tile to a number of (discrete) coordinates for further processing or analysis (for example, in normalized cross-correlation calculation to find maximum correlation between M1 and M2, as later described). Indeed, as will become apparent, reducing the size in this manner may reduce computational power required and/or reduce time required for identifying the correlation profile. In this embodiment, the coordinates of the centroids identified are specifically stored in a digital spreadsheet, although other storage mediums may be equally workable. To continue this example with a selection of centroids, the x-y coordinates thereof may be calculated and saved by the method 100 as follows:

x-y coordinates of centroids:
[(542.0, 1826.0), (573.0, 1818.0), (538.0, 1818.0), (211.0, 1729.0),
(1164.0, 1720.0), (1169.0, 1690.0), (1541.0, 1686.0), (1505.0, 1686.0),
(1332.0, 1683.0), (1163.0, 1683.0), (1296.0, 1683.0), (684.0, 1683.0),
(647.0, 1682.0)]

Notably, if 13 vias are present in the M1 tile, and 13 centroids are identified, then 13 data points or sets of coordinates are recorded, representing a further reduction in the size for processing from 2K×2K to 14 points. Thus, to reiterate, the M1 layer has been reduced from an 8K×8K image to a 2K×2K image, to eventually a list of digital coordinates which reflect the centroids of vias in the M1 layer. As vias represent the interlayer connective features in this embodiment, this coordinate data may be particularly useful for registration of the M1 and M2 layer, whilst requiring relatively little storage and/or processing power.

In this embodiment, the method 100 further comprises calculating a correlation profile based on the digital representations of the M1 and M2 layers, in accordance with a correlation function based, at least in part, on an alignment between the digital coordinates associated with the vias (as interlayer connective features) from the M1 layer and the wires (as intralayer connective features) identified in the M2 layer. In this particular embodiment, the correlation function generally comprises sliding the digital coordinates associated with the M1 layer over the M2 segmented layer. In particular, the correlation function specifically comprises normalized cross-correlation (NCC). As noted, the NCC calculation in this embodiment is based on the coordinates of each centroid (reflecting the via locations) in the M1 centroid tile and the segmented M2 tile. In particular, in this embodiment of NCC, the shift parameter is set to 0.3 multiplied by the size of the M1 layer (i.e. 0.3*block_size). Thus, to provide one non-limiting example, using the foregoing shift parameter and where “M2” is the M2 segmented tile, in this embodiment:

```
max = 0
best = undefined
for i in range(−shift , shift):
  for j in range(−shift , shift):
      s=0
      for (x,y) in centroids:
        s = s + M2[round(x+i)][round(y+j)]
  if s > max then
    max = s
    best = (i,j)
```

Once the correlation profile is calculated, the method 100 comprises identifying a profile feature in the correlation profile, which eventually informs registration of the layers (or more specifically, the digital representations thereof). In this embodiment, and the profile feature specifically comprises the maximum correlation in the correlation profile. Accordingly, the NCC calculation and the identification of the maximum correlation is based on a list of coordinates of vias from the M1 layer and a segmented image from the M2 layer, which offers reduced processing complexity and/or time, particularly as compared to undertaking NCC on two original images of the respective M1 and M2 layers, for example. In this embodiment of the method 100, identifying the profile feature in the correlation profile therefore comprises finding the maximum correlation between the coordinates associated with the M1 centroid tile and the M2 segmented tile, as well as the position of the maximum which, based on the above, is equal to the shift in x and y directions. In this embodiment and for exemplary purposes only, the maximum correlation of the correlation profile is identified as 13.004089843945094 and the position of the maximum is identified as (162,479) in the x and y directions. As such, this maximum correlation and/or the positioning of the maximum may be used to infer at least the logical relationship (and in this case, also physical relationship) between the M1 and M2 layers. Accordingly, in this embodiment, the method 100 serves to inform the alignment of the M1 and M2 layers, such that the layers can be “stacked” into a 3D construction reflective of the 3D arrangement thereof in the IC.

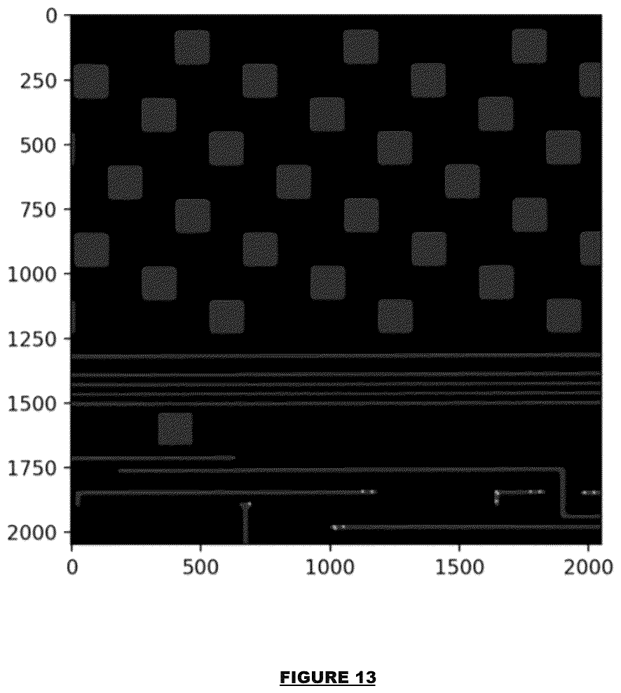

To further aid in the understanding of the foregoing implementation of the method 100, FIG. 13 provides a visualization of the M1 centroid tile and the M2 segmented tile in different viewing channels, after resolving the shift and therefore illustrating the registration or alignment obtained. Specifically, although colours are not shown in FIG. 13, the M1 and M2 layers are visualized in different greyscale channels (the visualization originally being generated in red-green-blue (RGB) channels, and later converted to greyscale for the instant disclosure) with the M1 centroid tile shown in one channel (initially the green channel) and the M2 segmented tile shown in another channel (initially the red channel). As such, in FIG. 13, the vias (as interlayer connective features) from the M1 centroid tile are reflected as distinct dots or spots on the lower portion (between 1750 and 2000 pixels on the y-axis) and the wires (as intralayer connective features) from the M2 segmented tile are reflected as the lines, in the remainder of FIG. 13 (the square blocks being other metal features). As shown, there appears to be a sound alignment between the M1 and M2 layers, as the vias are substantially aligned with the wires and are not, for example, substantially or noticeably offset therefrom. Such alignment may reflect the true interconnectivity between the M1 and M2 layers, as the vias connect wires on various IC layers. Notwithstanding same, in some embodiments, a pre-defined offset may be allowed as part of the method 100 in other embodiments.

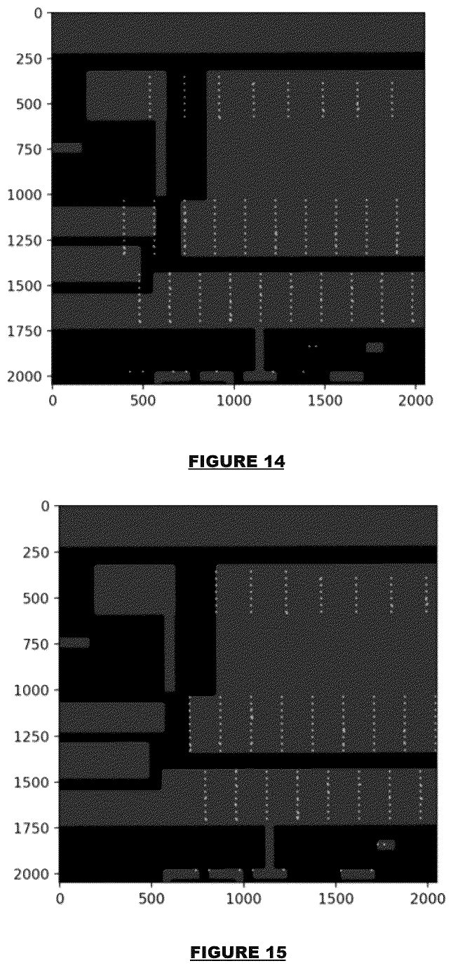

With reference now to FIGS. 14 to 20, further exemplary embodiments of the method 100 for registering respective digital representations of at least two interconnected layers of a multilayer dataset will be described. These examples are based on the exemplary original images shown in FIGS. 4 and 5, specifically as fragmented according to FIGS. 6 and 7, but particularly with reference to the tile pair or search space shown in row 2, column 3. Notably, the examples illustrated with reference to FIGS. 14 to 20 are purposively included to show specific refinements of the method 100 which may be employed in certain embodiments, and thus steps of the method 100 shared with any of the above methods are not repeated for the sake of brevity.

In some implementations, the size of the tiles (or search space) and/or the number of features (or specifically, vias) is insufficient to yield the maximum correlation or best match, and therefore several local maxima are obtained, potentially leading to an incorrect solution for the NCC and thus, potentially inaccurate registration.

As noted, during the NCC calculation, depending on the tile(s) processed, the maximum correlation (or best match) may be found or otherwise occur at different positions, thereby yielding several local maxima and potentially leading to an incorrect solution for the NCC (thus, the wrong maximum for registration). One exemplary output is shown in FIG. 14, which provides a greyscale visualization of respective portions of the M1 layer and the M2 layer in different channels again (both based on the tile pair shown in row 2, column 3), aligned based on the digital coordinates associated with the interlayer connective features (vias) in the first layer and the intralayer connective features (wires) in the second layer. As shown in FIG. 14, based on this tile pair and the features therein, the method 100 in this embodiment yields several local maxima which in this embodiment, leads to identification of the wrong profile feature (i.e., maximum) for image registration (or alignment), as illustrated by the offset nature of the dots or spots (vias) misaligning with the (metal) blocks. This is also observable in this embodiment as an outlier in the x and y coordinates recorded or stored as follows:

List of shifts in columns:
[479 474 93 470 479 484 160 475 182 490 488 0 0 107 357 0]
List of shifts in rows:
[162 161 156 155 162 161 156 159 163 164 174 0 0 441 581 0]

Therefore, in accordance with one embodiment, to solve or at least ameliorate this problem, one embodiment of the method 100 focusses the search for the maximum correlation on the median of the list of coordinates associated with any axis (or both axes) and applying NCC around the median. In this embodiment, selection of the median may be beneficial as the outliers are large, which would otherwise inordinately affect other statistical center measurements. Nonetheless, in other embodiments, other statistical center measurements may be employed as the focus of the search for the maximum correlation. Returning to the instant embodiment, which is focussed on the median of the coordinates, the following medians are identified in the respective x (row) and y (column) axes:

List of shifts in columns:
[479 474 462 470 479 479 472 475 451 464 473 0 0 467 474 0]
List of shifts in rows:
[162 161 157 155 162 162 161 159 160 160 150 0 0 159 153 0]
median of col_list:
471.0
median of row_list:
159.0

By calculating the medians of these coordinate lists and focusing the NCC thereon, this embodiment of the method 100 solves or ameliorates the occurrence of several local maxima, and the greyscale visualization of the M1 layer and the M2 layer in different channels again (both based on the tile pair shown in row 2, column 3), aligned based on the digital coordinates associated with the interlayer connective features (vias) in the first layer and the intralayer connective features (wires) in the second layer but focusing on the median of the respective coordinate lists. As shown in FIG. 15, this embodiment yields the correct maximum correlation and thus leading to sound layer registration, as illustrated by the aligned nature of the dots or spots with the blocks, specifically as compared to FIG. 14.

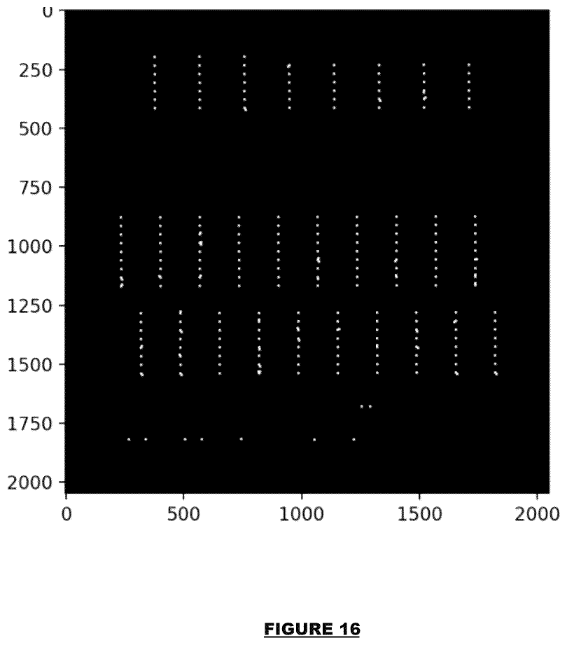

In FIG. 16, the M1 centroid tile of row 2, column 3 (hereinafter the “M1 tile 2-3”), of the digital representation shown in FIG. 6 is shown. Briefly, to obtain this digital representation, the original image (8K×8K) was fragmented into smaller tiles, the M1 tile 2-3 was selected (2K×2K), the M1 tile 2-3 was segmented based on metal representation, the segmented M1 tile 2-3 was contoured to identify vias, the centroid of each via location was determined and the coordinates thereof were saved (not shown). As such, the M1 tile 2-3 is reduced to a list of coordinates of the centroids, reflecting the vias. Indeed, it is to be appreciated that the digital representation of FIG. 16 may be reconstructed from the coordinate data stored from the foregoing processing of the M1 layer.

Turning now to another embodiment to solve or at least ameliorate the problem of several local maxima as described above (and as shown in FIG. 14 to produce an inaccurate registration), another embodiment of the method 100 focusses on increasing the size of the search space in the M2 layer or effectively, increasing the M2 tile size to include at least a portion of one or more neighbouring tiles. In one embodiment, the M1 tile (or at least, the coordinates extracted therefrom) remains the same, thus the coordinate list reflects the same 2K×2K tile, whereas the M2 tile is increased in size by adding portions of the neighbouring tiles thereto. As such, in some embodiments, by adding up to 1K in total from neighbouring tiles, the M2 tile or search space is increased from 2K×2K to 3K x 3K, and the coordinate list(s) from the M1 tile is compared thereto during application of the correlation function.

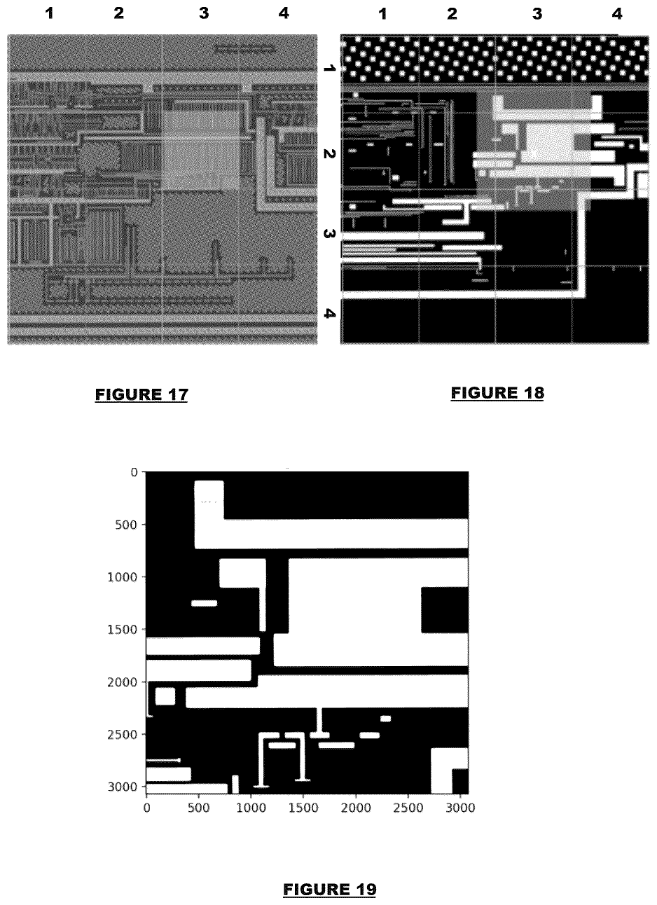

FIGS. 17 and 18 illustrate how, in one embodiment, the size of the corresponding tile in the M2 segmented layer is increased by adding thereto portions of neighbouring tiles summing up to 1K, such that the M2 tile (“M2 tile 3-2+”) is now approximately 3K in size. This M2 tile 3-2+ is shown as enlarged in FIG. 19. Although the word “adding” is used in this context, it is to be appreciated that such “adding” may be used interchangeably with the concept of “increasing the search area” of the selected tile to include surrounding portions, resulting in an overall increase in size of the search area (tile or tile plus some) under consideration. In this particular embodiment, as shown in FIG. 18, the M2 tile 3-2+includes the initial row 2, column 3 tile, plus a vertical strip of the tiles on the left and right, plus a horizontal strip of the tiles directly above and below, the additional tile portions summing up to 1K in this embodiment. Notably, other factor increases may be employed in different embodiments and/or other tile portion(s) may be incorporated in other embodiments.

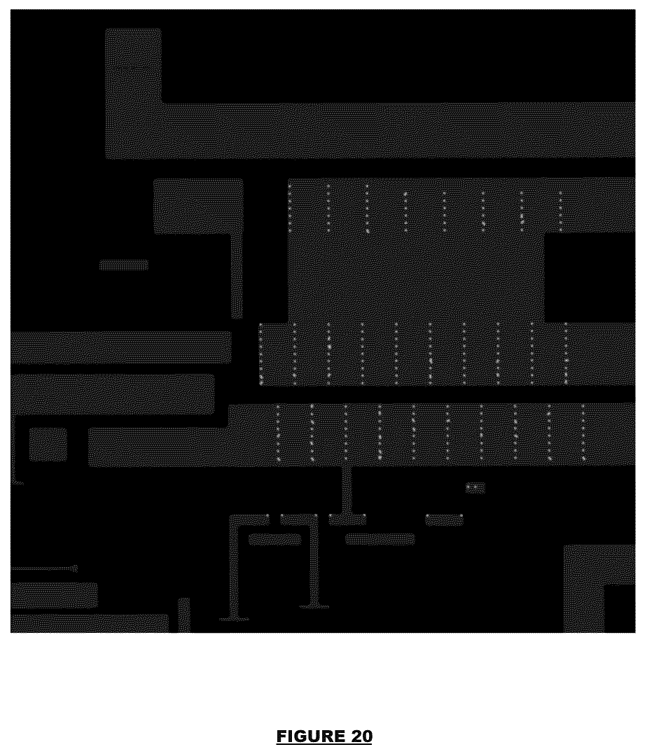

FIG. 20 shows a greyscale visualization of respective portions of the M1 layer and the M2 layer in different channels, aligned based on the digital coordinates associated with the interlayer connective features (vias) in the M1 layer and the intralayer connective features (wires) in the enlarged M2 layer (M2 tile 3-2+). As shown in FIG. 20, by increasing the size or search space of the M2 tile, this embodiment of the method 100 solves or at least ameliorates the occurrence of several local maxima. Indeed, as shown, this embodiment in which the M2 tile is increased in size yields the maximum correlation and thus leads to sound layer registration, as illustrated by the aligned nature of the dots or spots with the blocks, specifically as compared to FIG. 14. In this embodiment, after solving the shift or otherwise applying NCC, the shift values in row and column are as follows:

| List of shifts in columns: | |
|---|---|
| [478 475 621 470 479 484 482 475 480 488 542 0 0 433 44 0] | “List A” |
| List of shifts in rows: | |
| [162 165 156 155 162 161 159 159 160 161 598 0 0 436 159 0] | “List B” |

Accordingly, increasing the tile size may be employed together with, or separately from, reliance on the median, in different embodiments. FIG. 20 also illustrates that, in some embodiments, the method 100 may be operable to determine alignments using digital representations of larger object sizes or specifically, as shown in this embodiment, wide metal segments. FIG. 20 further illustrates that, in some embodiments, the method 100 may be operable to determine alignments using digital representations of highly scattered objects or specifically, as shown in this embodiment, scattered patterns of vias.

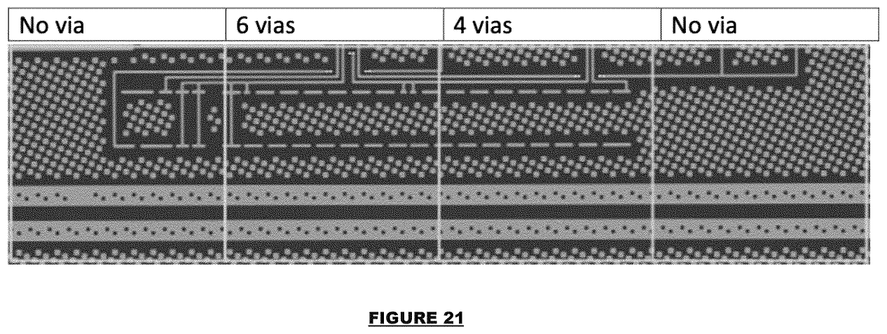

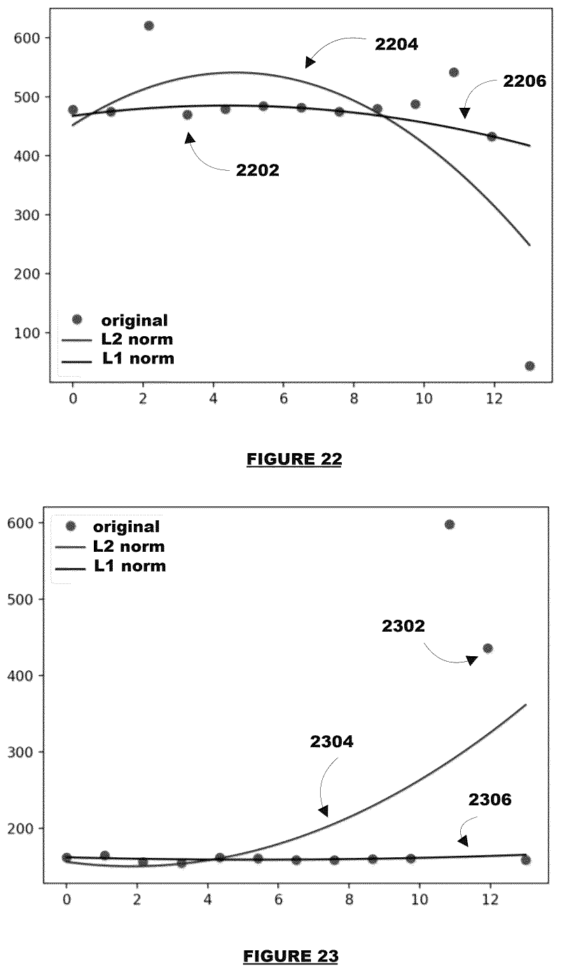

Turning now to FIG. 21, which shows an enlargement of row 4 of FIG. 6, it is to be noted that the tiles in this row do not contain any vias (as interlayer connective features) or otherwise contain a small number of vias (4 or 6), as shown. Tiles of this nature, having little to no vias present, predictably produce outliers during the determination of the correlation profile. In accordance with another embodiment to solve or at least ameliorate the problem of such outliers, which may be employed concurrently with or separately from the other features herein disclosed, one embodiment of the method eliminates such outliers using an L1 and/or L2 norm and fitting a polynomial to the data. In this embodiment, by filtering out the zeros and using L1 and L2 norms, the method fits polynomials to the shift values. Based on the results and as shown in this embodiment, the L1 norm generally yields more accurate results in the presence of outliers, as compared to the L2 norm. Put differently, the L1 norm is generally less susceptible to noise interference and/or outliers in the data, as compared to the L2 norm. One such exemplary embodiment is provided in FIGS. 22 and 23, which continues from the above example. In particular, to first fit the polynomial to the shift values in the columns, a list of shifts in columns previously determined is recalled, as noted above as List A. This List A of shifts in the columns is then run through the below function:

$$def f ( x , y , a , b , c , d ) : “ Function C ”$$

$$return a * ( x * x ) + b * ( x * y ) + c * ( y * y ) + d$$

Doing so determines the L2 and L1 coefficients in the columns as follows:

L2 coefficient:
[2.94648496 −4.16970009 13.09003117 38.02969603 121.58588601]
L1 coefficient:
[3.74344585 −0.91597633 2.14528794 35.6631011 −32.38583026]

Plotting the foregoing, FIG. 22 shows a graph of the fitting of the polynomial to the shift values in columns, showing the original values as circles/dots 2202, the L2 norm curve fitting as graph line 2204 and the L1 norm curve fitting as line 2206, to provide one non-limiting example. As shown in FIG. 22, the L1 norm is less impacted by the outliers in the original values.

To fit the polynomial to the shift values in the rows, a list of shifts in rows previously determined is recalled, as noted above as List B. This List B of shifts in the rows is then run through Function C noted above. Doing so determines the L2 and L1 coefficients in the rows as follows:

L2 coefficient:
[2.20875747 1.700312 −2.85006178 19.18275349 62.40160438]
L1 coefficient:
[9.70910096e−02 1.10453649e−01 −1.21482636e+01 4.13128071e+00
1.61961056e+02]

Plotting the foregoing, FIG. 23 shows a graph of the fitting of the polynomial to the shift values in rows, showing the original values as circles/dots 2302, the L2 norm curve fitting as graph line 2304 and the L1 norm curve fitting as line 2306, to provide one non-limiting example. As again shown in FIG. 23, the L1 norm is less impacted by the outliers in the original values.

Notably, whilst the L1 and L2 norms are utilized as exemplary implementations in this embodiment, with L1 outperforming L2, various embodiments may employ various alternative and/or additional norms and/or coefficients, which may have varying performance, depending on the datasets and/or other relevant parameters.

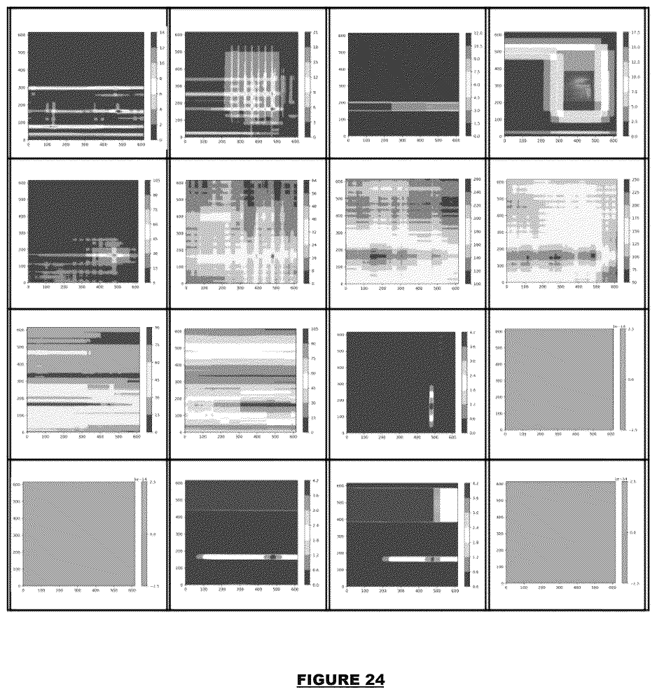

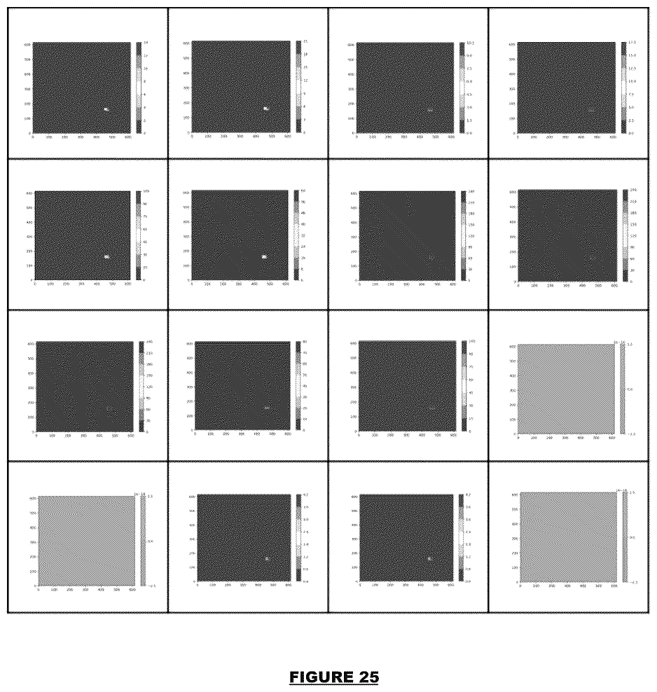

To further exemplify the registration or alignments possible with various embodiments of the method 100, FIGS. 24 and 25 provide heat maps or contour plots of various registrations or alignments, reflected in grayscale.

FIG. 24 specifically shows an array of heat maps or contour plots of further examples of sliding each tile from the first IC layer on its corresponding tile from the second IC layer to find the maxima, in accordance with one embodiment of the method 100. As such, with reference to FIG. 24, these alignments are attempted for each tile without the exemplary refinements of focusing on the median or otherwise increasing the size of the tile from the second IC layer (i.e., expanding the search space) described above. Indeed, the heat maps or contour plots of FIG. 24 reveal that in the general case, although certainly workable in some embodiments, in other embodiments such embodiments of the method 100 will reveal outliers. As such, in some embodiments or for some instances, several local maxima can be obtained, whilst in others, the maximum or match can be found at a plurality of different locations due to, for example, having wide wires or a lower number of vias which can correspond to (or match) in any direction with the second IC layer (metal layer). In the embodiment shown in FIG. 24, the shift values in row and column are as follows, thus representing several outliers:

Shift in columns:
[479 474 93 470 479 484 160 475 182 490 488 0 0 107 357 0]
Shift in rows:
[162 161 156 155 162 161 156 159 163 164 174 0 0 441 581 0]

FIG. 25 specifically shows an array of heat maps or contour plots of further examples of sliding each tile from the first IC layer on its corresponding tile from the second IC layer to find the maxima (or other extrema), in accordance with another embodiment of the method 100, which includes the refinement of increasing the size of the tile from the second IC layer (i.e., expanding the search space), as described above. As such, these alignments are attempted for each tile with the refinements of focusing on the median, and the expanded search space in the second IC layer. As such, the heat maps or contour plots of FIG. 25 reveal that in this refined case, expanding the search space in the second IC layer at least partly takes into account any or all of the features which are located proximate to or otherwise falling off the edge or border to the tile(s). As such, in some embodiments, this leads to a highly accurate estimation of the shifts in the rows and columns. Furthermore, in this embodiment, by focussing the search on the median of the coordinates from each heat map to find the extrema, many local extrema that may lead to an incorrect shift value and/or inaccurate registration, are eliminated. Overall, a comparison of FIGS. 24 and 25 reveals that whilst basic methods may be workable in certain embodiments, layers with high probability for local extrema may require one or more of the above refinements.

It is to be appreciated that refinement options similar to the foregoing may also be employed, for example, where the method 100 encounters several local minima or other profile feature(s) which cause noise or inaccuracies in the correlation profile, without limitation.

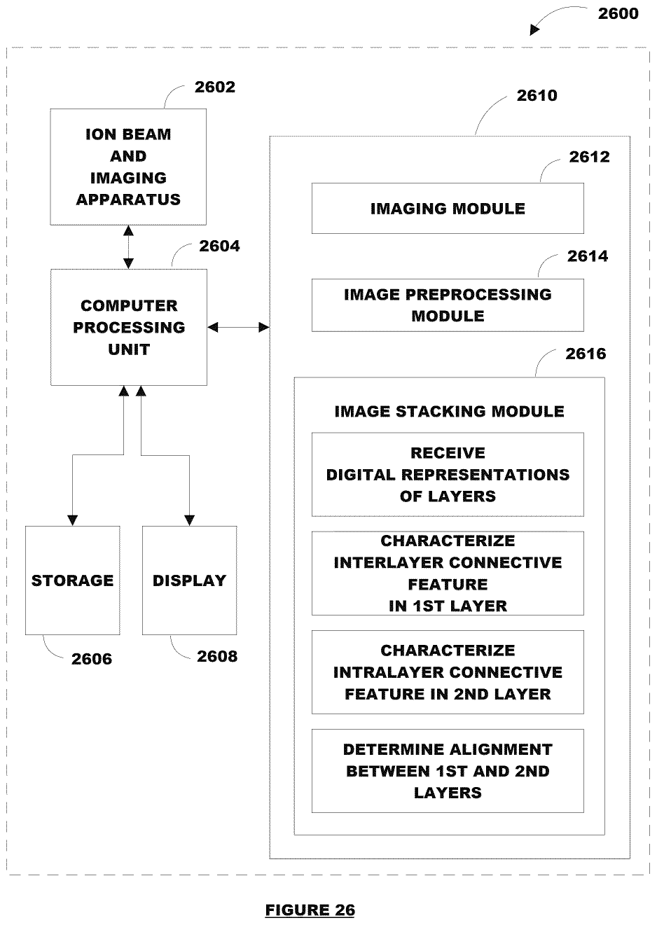

With reference now to FIG. 26, and in accordance with another exemplary embodiment of the instant disclosure, a system for acquiring images of layers of an IC and aligning or stacking such images to form or inform a 3D representation of the IC (or a portion thereof), generally referred to using reference numeral 2600, will now be described. In this embodiment, the IC is specifically intended to be reverse engineered, although the present disclosure is not limited to such an application. As such, there is no prior knowledge of the componentry or connectivity of the IC in this instance, and therefore feature or data extraction may be necessary to obtain knowledge thereof. Furthermore, registering the layers of the IC (or layout, typically vertical but may be in any direction) may be useful in reverse engineering the IC componentry or connectivity.

In this embodiment, the system 2600 comprises an ion beam and imaging apparatus 2602, a computer processing unit 2604 (CPU), a storage medium 2606 and a display 2608, although it is to be appreciated that other embodiments of the system 2600 may comprise other componentry and/or sub-systems.

The ion beam and imaging apparatus 2602, in this embodiment, is operable to etch layers away from the IC with the ion beam, and to capture images of respective layers of the IC revealed with the imaging apparatus. In this embodiment, the imaging apparatus comprises a SEM and the images captured are high-definition, two-dimensional SEM images which capture the details of the IC componentry and connections therein. It is to be appreciated that images of each respective IC layer are typically captured, and in some implementations, a plurality of images of a single layer may be captured (forming an array of images of a single layer) and may be potentially overlapping (for example, to ensure that features along edges/borders of images are not overlooked or otherwise misrepresented due to distortion or the like). All of the images captured of the IC may be saved as a multilayer dataset, optionally being sorted via layer (for example, all images of a single layer grouped together and in preprocessing, stitched together).

The CPU 2604, in this embodiment, is operable to carry out the imaging, image preprocessing and image stacking, as well as the storage of the data. The CPU 2604 is further operable to display data and/or receive user instructions via the display 2608. Thus, as shown in FIG. 26, the CPU 2604 interfaces with the ion beam and imaging apparatus 2602, the storage medium 2606, the display 2608 and a computer-readable medium 2610 (CRM), which comprises instructions for the foregoing.

As noted, in this embodiment, the system 2600 further comprises a CRM 2610, in accordance with another aspect of the disclosure, which comprises machine-executable instructions which when executed, enable the CPU 2604 (acting as at least one digital data processor) to carry out certain non-limiting steps pertaining to the registration (alignment or stacking) of the images to form or inform the 3D representation of the IC (or a portion thereof) and specifically, in this embodiment, the connectivity between layers.

As shown in FIG. 26, the CRM 2610 in this embodiment specifically comprises instructions to control the imaging 2612 (“imaging module”), including, for example, instructions to control the ion beam (movement, intensity or the like), the SEM (image acquisition rate, magnification, resolution or the like), translation of a stage, or the like, to provide some non-limiting examples. The CRM 2610 further comprises instructions for image preprocessing 2614 (“image preprocessing module”) to perform any preprocessing of the original images captured prior to core processing. For example, preprocessing instructions may include instructions to enhance the image(s) acquired, instructions to mark or retake an image of significantly low quality, or the like. In this embodiment, the instructions for image preprocessing 2614 include at least instructions for fragmenting the original images captured into smaller tiles for further processing (not shown). In this embodiment, the imaging module 2612 and image preprocessing module 2614 generally comprise conventional modules, comprising any one or more instructions for such purposes; thus, detailed description of same is omitted for the sake of brevity.

The CRM 2610 in this embodiment further comprises instructions to register, align or stack the images 2616 (“image stacking module”) to form or inform the 3D representation of the IC, or a portion thereof. In this embodiment, as shown in FIG. 26, the instructions on the CRM 2610 for image stacking 2616 specifically enable the CPU 2610 to receive digital representations of the layers of the IC. In this embodiment, for ease of reference, the system 2600 receives a first image tile of a first IC layer and a second image tile of a second IC layer (recall that the preprocessing module fragmented the original images to tiles, recall also that each layer may comprise thousands of images), wherein the first and second layers represent distinct vertically stackable layers of the IC (which may or may not have intervening layers without departing from the scope of the instant disclosure; for example, vias that extend, with or without connection through intervening layers from a first layer to a second layer). The instructions enable the CPU 2604 to retrieve the first and second image tiles from the storage 2606 in this embodiment, the first and second image tiles being stored in a temporary memory (for example, random access memory) for processing.

In this embodiment, the instructions on the CRM 2610 for image stacking 2616 further enable the CPU 2610 to process the first image tile of the first layer to characterize an interlayer connective feature represented therein. Notably, in this embodiment, the interlayer connective feature comprises a via, and if more than via is present, the instructions will enable the CPU 2610 to identify and/or characterize same (further, in some images, no vias will be present and the instructions will identify this). In this embodiment, characterizing the via(s) comprises identifying occurrences of vias in the first layer, demarcating the boundary or limits of each via, and determining a key location (such as the centroid) associated with each via. In this embodiment, characterizing the via(s) in the first layer reduces the ongoing storage requirement on the temporary memory from a 2K×2K image to the coordinates associated with the key location(s) of the via(s). In this specific embodiment, identifying the occurrences of vias is performed by the CPU 2604 by segmenting the first image tile (of the first layer) based on thresholding pertaining to metal representation to produce a segmented first digital representation, as elsewhere described. The segmented first digital representation reveals the vias. In this specific embodiment, demarcating the boundary or limits of each via is performed by the CPU 2604 by contouring the segmented first digital representation to identify therein one or more contoured locations (or boundaries or limits) of each via. In this specific embodiment, determining a key location associated with each via comprises determining a centroid for each via to provide digital coordinates associated therewith. The digital coordinates of the centroid of each via may be stored in the temporary memory or otherwise in storage 2606.

In this embodiment, the instructions on the CRM 2610 for image stacking 2616 further enable the CPU 2610 to process the second image tile (of the second layer) to characterize an intralayer connective feature represented therein. Notably, in this embodiment, the intralayer connective feature comprises a wire(s) present in the second layer. In this embodiment, characterizing the wire(s) comprises identifying occurrences and/or layout of wire(s) in the second layer, by means of segmenting the second image (of the second layer) based on thresholding pertaining to metal representation to produce a segmented second digital representation, wherein bare metal is reflected. In this embodiment, characterizing the wire(s) in the second layer does not specifically reduce the ongoing storage requirement on the temporary memory (the binary image is still 2K×2K) however, segmentation allows for relatively rapid identification of features of interest. In this embodiment, characterizing the wire(s) further comprises applying a blurring function to the segmented second digital representation, to account for any image artefacts, distortion or the like, particularly around borders/edges of the second image (notably, in other embodiments, blurring may be omitted entirely, else applied to both the first and second images, yet else selectively applied to images when necessary).

In this embodiment, the instructions on the CRM 2610 for image stacking 2616 further enable the CPU 2610 to determine an alignment or registration between the first image and the second image based on the via(s) (as interlayer connective features) characterized from the first image tile aligning with the wire(s) (as intralayer connective features) characterized from the second image tile. In this specific embodiment, the alignment or stacking between the first and second image tiles is based on the digital coordinates associated with one or more centroids of the via(s) from the first image tile with the wire(s) of second image tile (as segmented and blurred). As such, the alignment may be considered one which is logical and physical in this embodiment, since via(s) in one IC layer typically connect to wire(s) of another IC layer. In this embodiment, as the first and second images are of respective first and second layers which are vertically stackable, the alignment or registration determined in this embodiment is specifically reflective of a vertical alignment or stacking of the images based on the logical and/or physical interconnectivity between the layers. Other arrangements are possible some embodiments for aligning interconnectivity.

Notably, the alignment or registration of the first and second image tiles may be used to infer alignment or registration of further tiles, such as neighbouring tiles, and/or may be to infer alignment or registration of the original (larger) image. Otherwise, the image stacking module 2616 may process a large portion or all of the tiles and/or images so as to determine the alignment/registration of all images to obtain the 3D representation or a portion thereof.

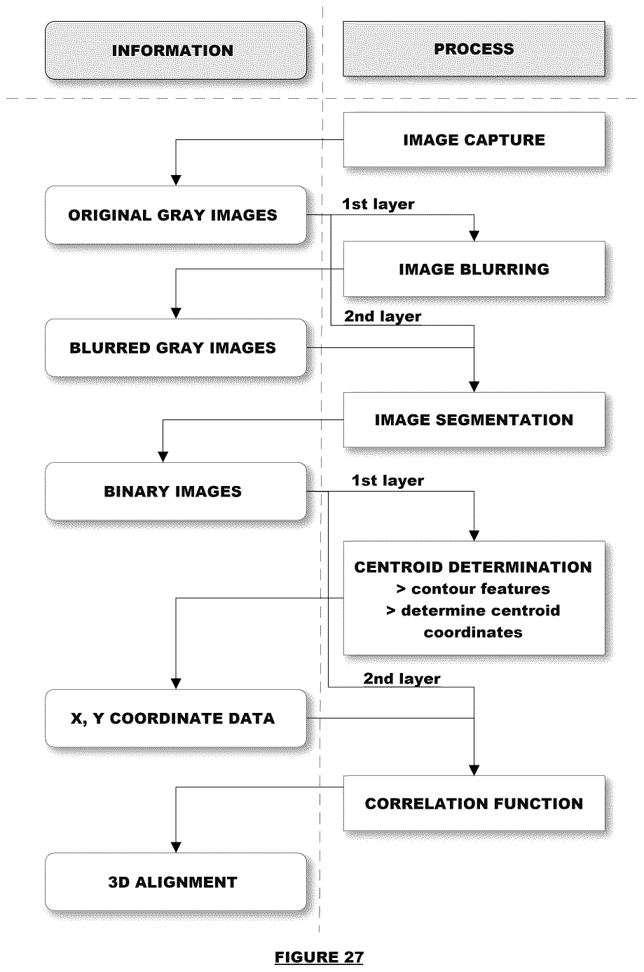

Finally, FIG. 27 provides a flow diagram of one exemplary operation of the system 2600 shown in FIG. 26, illustrating the processing and information obtained for forming or informing the 3D representation of the IC, or a portion thereof, in accordance with one embodiment. In FIG. 27, the right column illustrates the general process undertaken by the system 2600 and the left column illustrates the information obtained therefrom.

In this embodiment, the process commences with image capture, for example using the ion beam and imaging apparatus 2602 (SEM). In other embodiments, the images may have already been captured or acquired. In this specific embodiment, SEM images of each layer of the IC are obtained (being many), although for ease of reference, only first and second layers will be referred to. As shown, the images captured are original gray images of the layers of the IC, having a size of 8K×8K in this embodiment. In some embodiments, the original gray images may be fragmented into a grid of smaller tiles (for example, using a 4×4 grid), with the smaller tiles being individually used for further processing, as elsewhere described.

As shown, the original gray images may then undergo image segmentation, or otherwise may undergo image blurring before undergoing such image segmentation. In this specific embodiment, the first layer undergoes image blurring but the second layer does not (different to as described in system 2600). In particular, a blurring function is applied to the original gray image of the first layer, thereby producing a blurred gray image of the first layer. The blurred gray image of the first layer, in turn, is segmented to produce a binary image of the first layer. The binary image of the first layer, as shown, undergoes further processing before the correlation is determined. In this embodiment, the original gray image of the second layer, in contrast, is directly segmented (without blurring), to produce a binary image of the second layer. As shown, the binary image of the second layer is directly used for determining the correlation, as later described.

Returning to the further processing of the binary image of the first layer, in this embodiment, the features represented in the binary image of the first layer are contoured (or otherwise the boundaries or limits of same are identified) and the centroid of each feature is identified. Once the centroid of each feature is identified, the coordinates of those centroids are determined, and the x and y coordinate data is stored. As such, the x and y coordinates reflect the centroid positions of the features identified in the first layer, and these coordinates are used in the correlation function.

As shown in FIG. 27, the correlation function is based on the x and y coordinate data from the first layer, and the binary image of the second layer. In this embodiment, the correlation function comprises a NCC, and the maximum correlation is used to form or inform the 3D alignment between the first and second layers. Notably, the first and second layers need not be physically aligned, but the information regarding the alignment (i.e., maximum correlation) may be stored to recall same if/when needed.

The process shown in FIG. 27 may be repeated for a plurality of layers of an IC to be reverse engineered. Otherwise, the same process may be used in, for example, aligning geographical map data layers, street and traffic data layers, or the like, to name but a few non-limiting examples. Accordingly, the process is envisaged to be workable with respect to layers which may be physical or logical (conceptual), without limitation.

While the present disclosure describes various embodiments with specific reference to a method implementation, it is to be appreciated that similar steps and/or considerations may be equally applicable to related systems, which systems are intended to fall wholly within the present disclosure. Furthermore, similar steps and/or considerations may be equally applicable to related computer readable mediums. Indeed, in accordance with another embodiment of the instant disclosure, there is provided a computer-readable medium comprising machine-executable instructions which when executed, enable at least one digital data processor to execute the method 100 as described in any one or more of the above embodiments.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Except to the extent necessary or inherent in the processes themselves, no particular order to steps or stages of methods or processes described in this disclosure is intended or implied. In many cases the order of process steps may be varied without changing the purpose, effect, or import of the methods described.

Information as herein shown and described in detail is fully capable of attaining the above-described object of the present disclosure, the presently preferred embodiment of the present disclosure, and is, thus, representative of the subject matter which is broadly contemplated by the present disclosure. The scope of the present disclosure fully encompasses other embodiments which may become apparent to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are intended to be encompassed by the present claims. Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the disclosure.

1. A method for registering respective digital representations of at least two interconnected layers of a multilayer dataset, said respective digital representations at least partially corresponding with a common region shared between said at least two interconnected layers, the method automatically executed by at least one digital data processor and comprising:
receiving as input said respective digital representations of at least a first layer and a second layer of the multilayer dataset, said respective digital representations comprising location data of interlayer connective features and intralayer connective features;
calculating a correlation profile between said respective digital representations in accordance with a correlation function based, at least in part, on an alignment between digital coordinates associated with said interlayer connective features present in said first layer and said intralayer connective features present in said second layer; and
identifying a profile feature in said correlation profile to, at least in part, inform registration of respective digital representations which reflects at least logical interconnectivity between said first layer and said second layer.

2. The method of claim 1, wherein said receiving as input said respective digital representations comprises receiving segmented digital representations of any one or both of said first layer and said second layer.

3. The method of claim 1, wherein said receiving as input said respective digital representations comprises receiving digital images of said first layer and said second layer and wherein the method further comprises segmenting said digital images to provide segmented digital representations of any one or both of said first layer and said second layer.

4. The method of claim 1, wherein said calculating said correlation profile comprises identifying one or more related data layer feature locations associated with said interlayer connective features in a segmented digital representation of said first layer.

5. The method of claim 4, wherein said calculating said correlation profile further comprises determining a centroid for each of said one or more related data layer feature locations to provide said digital coordinates associated with said interlayer connective features.

6. The method of claim 1, wherein said correlation function comprises any one or both of shifting and/or stretching said digital coordinates associated with said interlayer connective features of said first layer with respect to said intralayer connective features of said second layer to calculate said correlation profile.

7. The method of any claim 1, wherein said correlation function comprises a normalized cross-correlation.

8. The method of claim 1, wherein said identifying said profile feature comprises identifying a maximum correlation in said correlation profile.

9. The method of claim 8, wherein said identifying said maximum correlation in said correlation profile comprises selecting a median of a list of coordinates associated with any axis and applying normalized cross-correlation thereto.

10. The method of claim 1, further comprising, prior to said calculating said correlation profile, applying a weighting function to any one or more of said respective digital representations so as to bias said calculating said correlation profile.

11. The method of claim 10, wherein said weighting function comprises a blurring function.

12. The method of claim 10, further comprising fragmenting any one or more of said respective digital representations into a grid of smaller tiles prior to said calculating said correlation profile.

13. The method of claim 12, further comprising increasing a size of a tile associated with said second layer to include a portion of one or more neighbouring tiles in said second layer; and wherein said calculating said correlation profile is based on a smaller tile from said first layer and a larger tile from said second layer, both corresponding to said common region.

14. The method of claim 1, wherein said logical interconnectivity between said first layer and said second layer corresponds with a spatial alignment between one or more of said interlayer connective features and one or more of said intralayer connective features.

15. The method of claim 1, wherein said multilayer dataset comprises an integrated circuit layer dataset and wherein said digital representations comprise microscopy images of said at least two interconnected layers of an integrated circuit.

16. The method of claim 1, wherein said interlayer connective features comprise one or more vias and wherein said intralayer connective features comprise one or more wires.

17. The method of claim 3, wherein said interlayer connective features comprise one or more vias and wherein said intralayer connective feature comprises one or more wires, and wherein said segmenting said digital images comprises:
segmenting said first layer based on representation of metal to identify said one or more vias; and
segmenting said second layer based on representation of metal and dielectric to identify said one or more wires.

18. The method of claim 1, forming part of a method for reverse engineering a layout of at least a part of an integrated circuit.

19. A non-transitory computer-readable medium comprising machine-executable instructions which when executed, enable at least one digital data processor to execute the method as claimed in claim 1.

20. A non-transitory computer-readable medium comprising machine-executable instructions which when executed, enable at least one digital data processor to:
receive at least a first digital representation of a first layer and a second digital representation of a second layer, wherein said first layer and said second layer comprise distinct stackable layers of a multilayer dataset;
process said first digital representation of said first layer to characterize an interlayer connective feature represented therein;
process said second digital representation of said second layer to characterize an intralayer connective feature represented therein; and
determine an alignment between said first digital representation and said second digital representation based on said interlayer connective feature characterized from said first digital representation aligning with said intralayer connective feature characterized from said second digital representation.

21. The computer-readable medium of claim 20, wherein said processing said first digital representation of said first layer to characterize an interlayer connective feature represented therein comprises any one of combination of:
segmenting said first digital representation of said first layer to produce a segmented first digital representation;
identifying one or more related data layer feature locations associated with said interlayer connective features in said segmented first digital representation; and
determining a centroid for each of said one or more related data layer feature locations to provide digital coordinates associated with said interlayer connective features.

22. The computer-readable medium of claim 21, wherein said determining said alignment between said first digital representation and said second digital representation comprises aligning digital coordinates associated with one or more centroids of said interlayer connective features with said intralayer connective feature of said second digital representation.
